(19) United States
(12) Patent Application Publication
(10) Pub. No.: US 2024/0413859 A1
(43) Pub. Date: Dec. 12, 2024

(54) TECHNIQUES FOR SOUNDING REFERENCE SIGNAL CONFIGURATIONS FOR UPLINK PANEL SELECTION

(71) Applicant: QUALCOMM INCORPORATED, San Diego, CA (US)

(72) Inventors: Fang Yuan, Beijing (CN); Yan Zhou, San Diego, CA (US); Wooseok Nam, San Diego, CA (US); Tao Luo, San Diego, CA (US); Junyi Li, Greentown, PA (US)

(21) Appl. No.: 18/700,620

(22) PCT Filed: Dec. 29, 2021
(86) PCT No.: PCT/CN2021/142312

§ 371 Date: Apr. 11, 2024

(51) Int. Cl. H04B 7/0404; H04B 7/06; H04L 5/00; H04W 24/10

(52) U.S. Cl. CPC H04B 7/0404; H04B 7/06956; H04L 5/0048; H04L 5/0055; H04W 24/10

(57) ABSTRACT

Methods, systems, and devices for wireless communications are described. A user equipment (UE) may be configured to transmit, to a base station, capability signaling indicating a quantity of sounding reference signal (SRS) ports supported by an antenna panel of a set of antenna panels at the UE. The UE may receive control signaling indicating an SRS configuration including multiple SRS sets, multiple SRS resource lists, or both, where the multiple SRS sets or multiple SRS resource lists are associated with respective quantities of supported SRS ports. The UE may then transmit, to the base station and based on the control signaling, a measurement report indicating a quantity of sounding SRS, and transmit an SRS to the base station in accordance with the SRS configuration and the indicated quantity of SRS ports.

### CROSS REFERENCE

The present Application is a 371 national stage filing of International PCT Application No. PCT/CN2021/142312 by YUAN et al. entitled “TECHNIQUES FOR SOUNDING REFERENCE SIGNAL CONFIGURATIONS FOR UPLINK PANEL SELECTION,” filed Dec. 29, 2021, which is assigned to the assignee hereof, and which is expressly incorporated by reference in its entirety herein.

### FIELD OF TECHNOLOGY

The following relates to wireless communications, including techniques for sounding reference signal (SRS) configurations for uplink panel selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless devices (e.g., UEs) may include multiple antenna panels to facilitate wireless communications, where the respective antenna panels support different communication capabilities. However, conventional techniques for selecting antenna panels which will be used for wireless communications are deficient.

### SUMMARY

The described techniques relate to improved methods, systems, devices, and apparatuses that support techniques for sounding reference signal (SRS) configurations for uplink panel selection. Generally, aspects of the present disclosure support signaling and configurations which enable user equipments (UEs) to be configured with multiple sounding reference signal (SRS) sets which enable UEs to identify which antenna panels and SRS sets will be used to transmit SRSs. For example, a UE may transmit capability signaling which indicates maximum quantities of SRS ports supported by each antenna panel at the UE. Subsequently, the network may configure the UE with an SRS configuration including multiple SRS sets or multiple SRS resource lists which support different quantities of SRS ports based on capabilities of respective antenna panels at the UE. The UE may then determine a quantity of SRS ports that it may support (e.g., based on measurements performed on channel state information reference signals (CSI-RSs) received from the base station), and may transmit SRSs in accordance with an SRS set or SRS resource list from the SRS configuration which corresponds to the identified quantity of supported SRS ports.

A method for wireless communication at a UE is described. The method may include transmitting, to a base station, capability signaling indicating a quantity of SRS ports supported by an antenna panel of a set of multiple antenna panels at the UE, receiving, from the base station in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, transmitting, to the base station and based on the control signaling, a measurement report indicating a quantity of SRS ports, and transmitting a SRS to the base station in accordance with the SRS configuration and the indicated quantity of SRS ports.

An apparatus for wireless communication at a UE is described. The apparatus may include a processor, memory coupled with the processor, and instructions stored in the memory. The instructions may be executable by the processor to cause the apparatus to transmit, to a base station, capability signaling indicating a quantity of SRS ports supported by an antenna panel of a set of multiple antenna panels at the UE, receive, from the base station in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, transmit, to the base station and based on the control signaling, a measurement report indicating a quantity of SRS ports, and transmit a SRS to the base station in accordance with the SRS configuration and the indicated quantity of SRS ports.

Another apparatus for wireless communication at a UE is described. The apparatus may include means for transmitting, to a base station, capability signaling indicating a quantity of SRS ports supported by an antenna panel of a set of multiple antenna panels at the UE, means for receiving, from the base station in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, means for transmitting, to the base station and based on the control signaling, a measurement report indicating a quantity of SRS ports, and means for transmitting a SRS to the base station in accordance with the SRS configuration and the indicated quantity of SRS ports.

A non-transitory computer-readable medium storing code for wireless communication at a UE is described. The code may include instructions executable by a processor to transmit, to a base station, capability signaling indicating a quantity of SRS ports supported by an antenna panel of a set of multiple antenna panels at the UE, receive, from the base station in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, transmit, to the base station and based on the control signaling, a measurement report indicating a quantity of SRS ports, and transmit a SRS to the base station in accordance with the SRS configuration and the indicated quantity of SRS ports.

In some examples of the method, apparatuses, and non-transitory computer-readable medium described herein, transmitting the SRS may include operations, features, means, or instructions for transmitting the SRS in accordance with a SRS set of the set of multiple SRS sets corresponding to the indicated quantity of SRS ports, or transmitting the SRS in accordance with a SRS resource list of the set of multiple SRS resource lists corresponding to the indicated quantity of SRS ports.

Some examples of the method, apparatuses, and non-transitory computer-readable medium described herein may further include operations, features, means, or instructions for selecting an antenna panel from the set of multiple antenna panels at the UE based on the indicated quantity of SRS ports, where the SRS may be transmitted via the selected antenna panel.

In some examples of the method, apparatuses, and non-transitory computer-readable medium described herein, and the method, apparatuses, and non-transitory computer-readable medium may include further operations, features, means, or instructions for transmitting, via the measurement report, an indication of the first quantity of supported SRS ports, where the SRS may be transmitted in accordance with the first SRS set.

In some examples of the method, apparatuses, and non-transitory computer-readable medium described herein, the first SRS set may be associated with a first set of parameters and the second SRS set may be associated with a second set of parameters that may be the same or different from the first set of parameters and the first set of parameters, the second set of parameters, or both, include a unified transmission configuration indicator (TCI) state, a power control parameter, a periodicity, a corresponding CSI-RS, an aperiodic trigger, an offset, or any combination thereof.

In some examples of the method, apparatuses, and non-transitory computer-readable medium described herein, and the method, apparatuses, and non-transitory computer-readable medium may include further operations, features, means, or instructions for transmitting, via the measurement report, an indication of the first quantity of supported SRS ports, where the SRS may be transmitted in accordance with the first SRS resource list.

In some examples of the method, apparatuses, and non-transitory computer-readable medium described herein, the first SRS resource list may be associated with a first set of parameters and the second SRS resource list may be associated with a second set of parameters different from the first set of parameters and the first set of parameters, the second set of parameters, or both, include a unified TCI state, a power control parameter, a periodicity, a corresponding CSI-RS, an aperiodic trigger, an offset, or any combination thereof.

Some examples of the method, apparatuses, and non-transitory computer-readable medium described herein may further include operations, features, means, or instructions for receiving, via the control signaling, additional control signaling, or both, an indication of a second SRS configuration associated with a second bandwidth part (BWP), a second component carrier, or both, where the second SRS configuration includes a second set of multiple SRS sets, a second set of multiple SRS resources lists, or both, where the second set of multiple SRS sets and the second set of multiple SRS resource lists may be associated with respective quantities of supported SRS ports.

In some examples of the method, apparatuses, and non-transitory computer-readable medium described herein, and the method, apparatuses, and non-transitory computer-readable medium may include further operations, features, means, or instructions for receiving, from the base station and based on the SRS configuration, additional control signaling including an indication of a second SRS set, a second SRS resource list, or both and transmitting, to the base station based on the additional control signaling, a second SRS in accordance with the second SRS set, the second SRS resource list, or both.

Some examples of the method, apparatuses, and non-transitory computer-readable medium described herein may further include operations, features, means, or instructions for transmitting an acknowledgement message to the base station in response to the additional control signaling, where the second SRS may be transmitted based on the acknowledgement message.

In some examples of the method, apparatuses, and non-transitory computer-readable medium described herein, transmitting the second SRS may include operations, features, means, or instructions for transmitting the second SRS after an expiration of a time interval, where the time interval may be initiated based on transmitting the acknowledgement message.

In some examples of the method, apparatuses, and non-transitory computer-readable medium described herein, the indication of the second SRS set, the second SRS resource list, or both, may be indicated via one or more bit fields within the additional control signaling and the one or more bit fields include a SRS resource identifier field, a transmit precoder metrics indicator field, or both.

In some examples of the method, apparatuses, and non-transitory computer-readable medium described herein, the indication of the second SRS set, the second SRS resource list, or both, may be indicated via a UE capability identifier, a SRS set identifier, a SRS resource list identifier, or any combination thereof.

Some examples of the method, apparatuses, and non-transitory computer-readable medium described herein may further include operations, features, means, or instructions for performing one or more measurements on a downlink reference signal received from the base station and transmitting, to the base station, a second measurement report based on the one or more measurements, the second measurement report indicating a second quantity of SRS ports, where the additional control signaling may be received based on the second measurement report.

In some examples of the method, apparatuses, and non-transitory computer-readable medium described herein, the additional control signaling includes a downlink control information (DCI) message, a medium access control-control element (MAC-CE) message, a radio resource control (RRC) reconfiguration message, or any combination thereof.

Some examples of the method, apparatuses, and non-transitory computer-readable medium described herein may further include operations, features, means, or instructions for receiving, via the additional control signaling, an indication of a deactivation of the first SRS set, the first SRS resource list, or both, where transmitting the second SRS may be based on receiving the indication of the deactivation.

In some examples of the method, apparatuses, and non-transitory computer-readable medium described herein, the additional control signaling includes a MAC-CE message and the indication of the second SRS set, the second SRS resource list, or both, may be indicated via an activation of a TCI.

In some examples of the method, apparatuses, and non-transitory computer-readable medium described herein, the additional control signaling includes a BWP message and the indication of the second SRS set, the second SRS resource list, or both, may be indicated via an indication of a TCI codepoint, a TCI field, or both.

In some examples of the method, apparatuses, and non-transitory computer-readable medium described herein, the additional control signaling includes a BWP message associated with a request for SRSs and the indication of the second SRS set, the second SRS resource list, or both, may be indicated via a SRS request field.

Some examples of the method, apparatuses, and non-transitory computer-readable medium described herein may further include operations, features, means, or instructions for transmitting, via the capability signaling, an indication of a first quantity of SRS ports supported by the first antenna panel and a second quantity of SRS ports supported by the second antenna panel.

Some examples of the method, apparatuses, and non-transitory computer-readable medium described herein may further include operations, features, means, or instructions for receiving, via the control signaling, an indication of one or more periodicities associated with the SRS configuration, where transmitting the SRS includes transmitting a set of multiple SRSs in accordance with a periodicity from the one or more periodicities.

In some examples of the method, apparatuses, and non-transitory computer-readable medium described herein, the SRS configuration may be associated with codebook-based communications between the UE and the base station, non-codebook-based communications between the UE and the base station, or both.

Some examples of the method, apparatuses, and non-transitory computer-readable medium described herein may further include operations, features, means, or instructions for receiving a downlink reference signal from the base station and performing one or more measurements on the downlink reference signal, where transmitting the measurement report may be based on the one or more measurements.

In some examples of the method, apparatuses, and non-transitory computer-readable medium described herein, the control signaling includes an RRC message and the measurement report includes a channel state information report associated with a channel between the UE and the base station.

A method for wireless communication at a base station is described. The method may include receiving, from a UE, capability signaling indicating a quantity of SRS ports supported by an antenna panel of a set of multiple antenna panels at the UE, transmitting, to the UE in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, receiving, from the UE and based on the control signaling, a measurement report indicating a quantity of SRS ports, and receiving a SRS from the UE in accordance with the SRS configuration and the indicated quantity of SRS ports.

An apparatus for wireless communication at a base station is described. The apparatus may include a processor, memory coupled with the processor, and instructions stored in the memory. The instructions may be executable by the processor to cause the apparatus to receive, from a UE, capability signaling indicating a quantity of SRS ports supported by an antenna panel of a set of multiple antenna panels at the UE, transmit, to the UE in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, receive, from the UE and based on the control signaling, a measurement report indicating a quantity of SRS ports, and receive a SRS from the UE in accordance with the SRS configuration and the indicated quantity of SRS ports.

Another apparatus for wireless communication at a base station is described. The apparatus may include means for receiving, from a UE, capability signaling indicating a quantity of SRS ports supported by an antenna panel of a set of multiple antenna panels at the UE, means for transmitting, to the UE in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, means for receiving, from the UE and based on the control signaling, a measurement report indicating a quantity of SRS ports, and means for receiving a SRS from the UE in accordance with the SRS configuration and the indicated quantity of SRS ports.

A non-transitory computer-readable medium storing code for wireless communication at a base station is described. The code may include instructions executable by a processor to receive, from a UE, capability signaling indicating a quantity of SRS ports supported by an antenna panel of a set of multiple antenna panels at the UE, transmit, to the UE in response to the capability signaling, control signaling indicating a SRS configuration including a set of multiple SRS sets, a set of multiple SRS resource lists, or both, where the set of multiple SRS sets or the set of multiple SRS resource lists are associated with respective quantities of supported SRS ports, receive, from the UE and based on the control signaling, a measurement report indicating a quantity of SRS ports, and receive a SRS from the UE in accordance with the SRS configuration and the indicated quantity of SRS ports.

In some examples of the method, apparatuses, and non-transitory computer-readable medium described herein, receiving the SRS may include operations, features, means, or instructions for receiving the SRS in accordance with a SRS set of the set of multiple SRS sets corresponding to the indicated quantity of SRS ports, or receiving the SRS in accordance with a SRS resource list of the set of multiple SRS resource lists corresponding to the indicated quantity of SRS ports.

In some examples of the method, apparatuses, and non-transitory computer-readable medium described herein, and the method, apparatuses, and non-transitory computer-readable medium may include further operations, features, means, or instructions for receiving, via the measurement report, an indication of the first quantity of supported SRS ports, where the SRS may be received in accordance with the first SRS set.

In some examples of the method, apparatuses, and non-transitory computer-readable medium described herein, the first SRS set may be associated with a first set of parameters and the second SRS set may be associated with a second set of parameters that may be the same or different from the first set of parameters and the first set of parameters, the second set of parameters, or both, include a unified TCI state, a power control parameter, a periodicity, a corresponding CSI-RS, an aperiodic trigger, an offset, or any combination thereof.

In some examples of the method, apparatuses, and non-transitory computer-readable medium described herein, and the method, apparatuses, and non-transitory computer-readable medium may include further operations, features, means, or instructions for receiving, via the measurement report, an indication of the first quantity of supported SRS ports, where the SRS may be received in accordance with the first SRS resource list.

In some examples of the method, apparatuses, and non-transitory computer-readable medium described herein, the first SRS resource list may be associated with a first set of parameters and the second SRS resource list may be associated with a second set of parameters different from the first set of parameters and the first set of parameters, the second set of parameters, or both, include a unified TCI state, a power control parameter, a periodicity, a corresponding CSI-RS, an aperiodic trigger, an offset, or any combination thereof.

Some examples of the method, apparatuses, and non-transitory computer-readable medium described herein may further include operations, features, means, or instructions for transmitting, via the control signaling, additional control signaling, or both, an indication of a second SRS configuration associated with a second BWP, a second component carrier, or both, where the second SRS configuration includes a second set of multiple SRS sets, a second set of multiple SRS resources lists, or both, where the second set of multiple SRS sets and the second set of multiple SRS resource lists may be associated with a respective quantity of supported SRS ports.

In some examples of the method, apparatuses, and non-transitory computer-readable medium described herein, and the method, apparatuses, and non-transitory computer-readable medium may include further operations, features, means, or instructions for transmitting, to the UE and based on the SRS configuration, additional control signaling including an indication of a second SRS set, a second SRS resource list, or both and receiving, from the UE based on the additional control signaling, a second SRS in accordance with the second SRS set, the second SRS resource list, or both.

Some examples of the method, apparatuses, and non-transitory computer-readable medium described herein may further include operations, features, means, or instructions for receiving an acknowledgement message to the base station in response to the additional control signaling, where the second SRS may be receiving based on the acknowledgement message.

In some examples of the method, apparatuses, and non-transitory computer-readable medium described herein, receiving the second SRS may include operations, features, means, or instructions for receiving the second SRS after an expiration of a time interval.

In some examples of the method, apparatuses, and non-transitory computer-readable medium described herein, the indication of the second SRS set, the second SRS resource list, or both, may be indicated via one or more bit fields within the additional control signaling and the one or more bit fields include a SRS resource identifier field, a transmit precoder metrics indicator field, or both.

In some examples of the method, apparatuses, and non-transitory computer-readable medium described herein, the indication of the second SRS set, the second SRS resource list, or both, may be indicated via a UE capability identifier, a SRS set identifier, a SRS resource list identifier, or any combination thereof.

Some examples of the method, apparatuses, and non-transitory computer-readable medium described herein may further include operations, features, means, or instructions for transmitting a downlink reference signal to the UE and receiving, from the UE, a second measurement report based on the downlink reference signal, the second measurement report indicating a second quantity of SRS ports, where the additional control signaling may be transmitted based on the second measurement report.

In some examples of the method, apparatuses, and non-transitory computer-readable medium described herein, the additional control signaling includes a BWP message, a MAC-CE message, an RRC reconfiguration message, or any combination thereof.

Some examples of the method, apparatuses, and non-transitory computer-readable medium described herein may further include operations, features, means, or instructions for transmitting, via the additional control signaling, an indication of a deactivation of the first SRS set, the first SRS resource list, or both, where receiving the second SRS may be based on transmitting the indication of the deactivation.

In some examples of the method, apparatuses, and non-transitory computer-readable medium described herein, the additional control signaling includes a MAC-CE message and the indication of the second SRS set, the second SRS resource list, or both, may be indicated via an activation of a TCI.

In some examples of the method, apparatuses, and non-transitory computer-readable medium described herein, the additional control signaling includes a BWP message and the indication of the second SRS set, the second SRS resource list, or both, may be indicated via an indication of a TCI codepoint, a TCI field, or both.

In some examples of the method, apparatuses, and non-transitory computer-readable medium described herein, the additional control signaling includes a BWP message associated with a request for SRSs and the indication of the second SRS set, the second SRS resource list, or both, may be indicated via a SRS request field.

Some examples of the method, apparatuses, and non-transitory computer-readable medium described herein may further include operations, features, means, or instructions for receiving, via the capability signaling, an indication of a first quantity of SRS ports supported by the first antenna panel and a second quantity of SRS ports supported by the second antenna panel.

Some examples of the method, apparatuses, and non-transitory computer-readable medium described herein may further include operations, features, means, or instructions for transmitting, via the control signaling, an indication of one or more periodicities associated with the SRS configuration, where receiving the SRS includes receiving a set of multiple SRSs in accordance with a periodicity from the one or more periodicities.

In some examples of the method, apparatuses, and non-transitory computer-readable medium described herein, the SRS configuration may be associated with codebook-based communications between the UE and the base station, non-codebook-based communications between the UE and the base station, or both.

Some examples of the method, apparatuses, and non-transitory computer-readable medium described herein may further include operations, features, means, or instructions for transmitting a downlink reference signal from the base station, where receiving the measurement report may be based on the downlink reference signal.

In some examples of the method, apparatuses, and non-transitory computer-readable medium described herein, the control signaling includes an RRC message and the measurement report includes a channel state information report associated with a channel between the UE and the base station.

### BRIEF DESCRIPTION OF THE DRAWINGS

FIG. 1 illustrates an example of a wireless communications system that supports techniques for sounding reference signal (SRS) configurations for uplink panel selection in accordance with aspects of the present disclosure.

FIG. 2 illustrates an example of a wireless communications system that supports techniques for SRS configurations for uplink panel selection in accordance with aspects of the present disclosure.

FIG. 3 illustrates an example of a process flow that supports techniques for SRS configurations for uplink panel selection in accordance with aspects of the present disclosure.

FIGS. 4 and 5 show block diagrams of devices that support techniques for SRS configurations for uplink panel selection in accordance with aspects of the present disclosure.

FIG. 6 shows a block diagram of a communications manager that supports techniques for SRS configurations for uplink panel selection in accordance with aspects of the present disclosure.

FIG. 7 shows a diagram of a system including a device that supports techniques for SRS configurations for uplink panel selection in accordance with aspects of the present disclosure.

FIGS. 8 and 9 show block diagrams of devices that support techniques for SRS configurations for uplink panel selection in accordance with aspects of the present disclosure.

FIG. 10 shows a block diagram of a communications manager that supports techniques for SRS configurations for uplink panel selection in accordance with aspects of the present disclosure.

FIG. 11 shows a diagram of a system including a device that supports techniques for SRS configurations for uplink panel selection in accordance with aspects of the present disclosure.

FIGS. 12 through 15 show flowcharts illustrating methods that support techniques for SRS configurations for uplink panel selection in accordance with aspects of the present disclosure.

### DETAILED DESCRIPTION

Some wireless devices (e.g., user equipments (UEs)) may include multiple antenna panels to facilitate wireless communications, where the respective antenna panels support different quantities of physical layers, or different quantities of sounding reference signal (SRS) ports. For example, a UE may include first and second antenna panels, where the first antenna panel supports up to two SRS ports (e.g., up to two layers), and where the second antenna panel supports up to four SRS ports (e.g., up to four layers). Thus, when performing wireless communications according to a given quantity of SRS ports/layers, the UE may have to select the respective antenna panel which will support the respective quantity of SRS ports/layers. Some wireless communications systems only enable UEs to be configured with a single SRS resource set, whereas other wireless communications systems may enable UEs to be configured with two or more SRS resource sets. In cases where the UE may be configured with multiple SRS resource sets, it may be unclear which antenna panel, and which SRS resource set, should be used for transmitting SRSs.

Accordingly, some aspects of the present disclosure are directed to signaling and configurations which enable UEs to be configured with multiple SRS sets which enable UEs to identify which antenna panels and SRS sets will be used to transmit SRSs. For example, a UE may transmit capability signaling which indicates maximum quantities of SRS ports supported by each antenna panel at the UE. Subsequently, the network may configure the UE with an SRS configuration including multiple SRS sets or multiple SRS resource lists which support different quantities of SRS ports based on capabilities of respective antenna panels at the UE. The UE may then determine a quantity of SRS ports that it may support, for example, based on measurements performed on channel state information reference signals (CSI-RSs) received from the base station. In this example, the UE may transmit SRSs in accordance with an SRS set or SRS resource list from the SRS configuration which corresponds to the identified quantity of supported SRS ports.

In accordance with some aspects of the present disclosure, the network may dynamically change/update the SRS set(s), the SRS resource list(s), or both, which is used by the UE to transmit SRSs. Dynamic updates to SRS sets/SRS resource lists may be indicated via downlink control information (DCI) messages, medium access control (MAC) control element (MAC-CE) messages, radio resource control (RRC) reconfiguration messages, or any combination thereof. In some cases, the network may dynamically update an SRS set/SRS resource list used by the UE based on updated measurement reports indicating that the UE may support different quantities of SRS ports.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to techniques for SRS configurations for uplink panel selection.

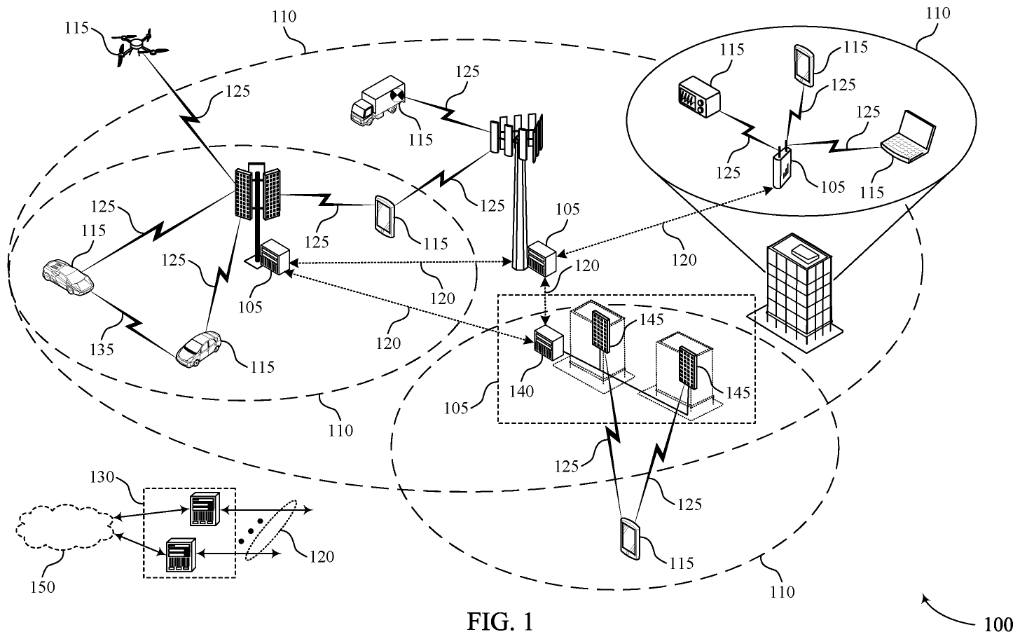

FIG. 1 illustrates an example of a wireless communications system 100 that supports techniques for SRS configurations for uplink panel selection in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some aspects, the UEs 115 and the base stations 105 of the wireless communications system 100 may support signaling and configurations which enable UEs 115 to be configured with multiple SRS sets which enable the UEs 115 to identify which antenna panels and SRS sets will be used to transmit SRSs. In this regard, the devices of the wireless communications system 100 may support signaling and other configurations which enable UEs 115 to quickly and efficiently identify antenna panels and corresponding SRS sets, SRS resource lists, or both, which will be used for wireless communications between the respective UEs 115 and the network (e.g., base station 105). The antenna panel may be associated with at least one SRS resource set. In some aspects, the antenna panel may be explicitly identified by an antenna panel ID. In some other aspects, the antenna panel may be implicitly associated with some other channel and identified by the other channel ID, such as a CORESET pool index, close loop index, SRS resource set ID, transmit configuration indicator ID, and the like.

For example, a UE 115 of the wireless communications system 100 may transmit capability signaling which indicates maximum quantities of SRS ports supported by each antenna panel at the UE 115. Subsequently, the network (e.g., base station 105) may configure the UE 115 with an SRS configuration including multiple SRS sets for MIMO uplink transmission, multiple SRS resource lists, or both, which support different quantities of SRS ports based on capabilities of respective antenna panels at the UE. For example, the network may indicate an SRS configuration including a first SRS set or first SRS resource list which supports up to two SRS ports (e.g., up to two layers) and a second SRS set or second SRS resource list which supports up to four SRS ports (e.g., up to four layers), where the SRS resource set(s) may be configured for a usage of codebook based MIMO uplink transmission, or non-codebook based MIMO uplink transmission. The UE may then determine a quantity of SRS ports that it may support, for example, based on measurements performed on channel state information reference signals (CSI-RSs) received from the base station, and may transmit SRSs in accordance with the SRS configuration and identified quantity of SRS ports. For instance, in this example, if the UE 115 determines that it can support up to four SRS ports, the UE 115 may transmit SRSs in accordance with the second SRS set and/or SRS resource list within the SRS configuration which support up to four SRS ports.

In accordance with some aspects of the present disclosure, the network of the wireless communications system 100 may dynamically change/update the SRS set/SRS resource list which is used by each UE 115 to transmit SRSs. Dynamic updates to SRS sets/SRS resource lists may be indicated via DCI messages, MAC-CE messages, RRC reconfiguration messages, or any combination thereof. In some cases, the network may dynamically update an SRS set/SRS resource list used by the UE 115 based on updated measurement reports indicating that the UE 115 may support different quantities of SRS ports. For instance, if a UE 115 indicates in a first CSI report that it is able to support up to four SRS ports for MIMO uplink transmission, and subsequently indicates in a second CSI report that it is only able to support up to two SRS ports, the network may dynamically update the SRS set/SRS resource list used by the UE 115 (e.g., via DCI signaling, MAC-CE signaling) based on the changed quantity of SRS ports supported at the UE 115.

Techniques described herein may support signaling and configurations which enable UEs 115 to quickly and efficiently identify SRS sets, SRS resource lists, or both, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of MIMO layers in uplink, quantities of SRS ports, or both, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system 100.

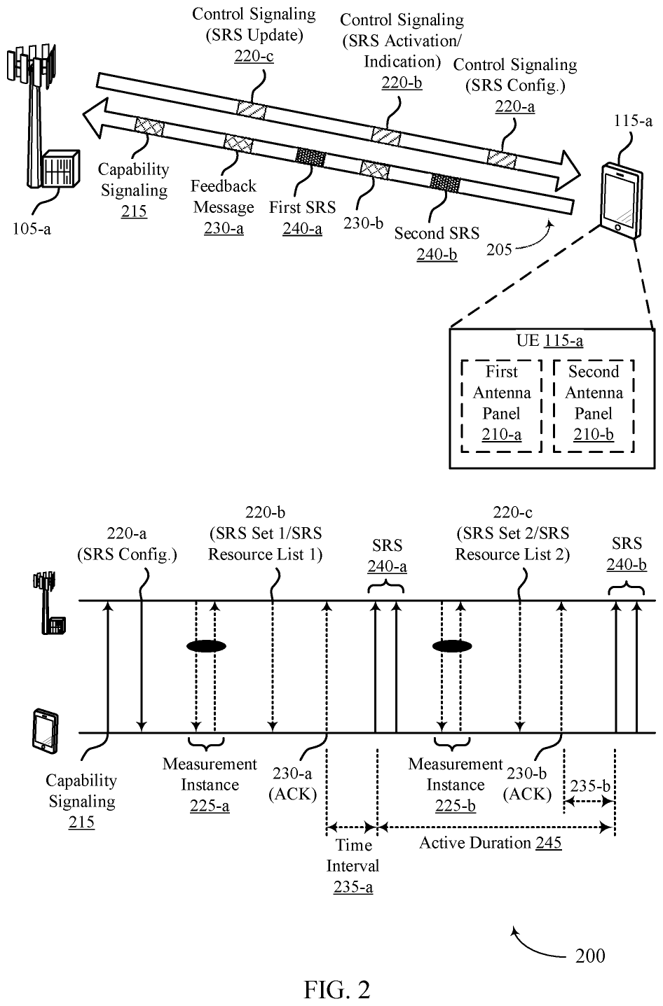

FIG. 2 illustrates an example of a wireless communications system 200 that supports techniques for SRS configurations for uplink panel selection in accordance with aspects of the present disclosure. In some examples, wireless communications system 200 may implement, or be implemented by, aspects of wireless communications system 100. For example, wireless communications system 200 may support signaling and configurations which enable UEs 115 to be configured with multiple SRS sets which support varying quantities of layers/SRS ports, which enables UEs 115 to efficiently identify which antenna panels and SRS sets will be used to transmit SRSs to the network, as described in FIG. 1.

The wireless communications system 200 may include a base station 105-a and a UE 115-a, which may be examples base stations 105 and UEs 115 as described with reference to FIG. 1. The UE 115-a may communicate with the base station 105-a using a communication link 205, which may be an example of an NR or LTE link between the UE 115-a and the base station 105-a. In some cases, the communication link 205 between the UE 115-a and the base station 105-a may include an example of an access link (e.g., Uu link) which may include a bi-directional link that enables both uplink and downlink communication. For example, the UE 115-a may transmit uplink signals, such as uplink control signals or uplink data signals (e.g., SRSs), to the base station 105-a using the communication link 205, and the base station 105-a may transmit downlink signals, such as downlink control signals or downlink data signals, to the UE 115-a using the communication link 205.

As noted previously herein, some wireless devices (e.g., UEs 115) may include multiple antenna panels to facilitate wireless communications, where the respective antenna panels support different quantities of physical layers, or different quantities of SRS ports. For example, a UE 115 may include first and second antenna panels, where the first antenna panel supports up to two SRS ports (e.g., up to two layers), and where the second antenna panel supports up to four SRS ports (e.g., up to four layers).

Some wireless communications systems may support different implementations for UE-initiated antenna panel and selection. In other words, there are several implementations which may be used to determine which SRS sets and/or antenna panels will be used for transmitting SRSs at a UE 115. In accordance with a first implementation, a panel entity may correspond to a reported CSI-RS and/or SSB resource index in a beam reporting instance from the UE 115. In other words, the antenna panel selected by a UE 115 may be based on a CSI-RS report or SSB resource index reported by a UE 115. In this regard, the correspondence between the panel entity and the reported CSI-RS and/or SSB resource index may be determined by the UE 115 and reported to the network. In such cases, the SRS resource indicator (SRI) indicated by the UE 115 may be based on the SRS resources corresponding to one SRS resource set, where the SRS resource set should be aligned with the UE 115 capability for the panel entity. The first implementation for UE-initiated antenna panel activation and selection may support UE 115 reporting of maximum number of SRS ports and coherence type for each panel entity as a UE capability, and may support multiple codebook-based SRS resource sets with different maximum numbers of supported SRS ports.

Comparatively, in accordance with a second implementation for UE-initiated antenna panel activation and selection, a UE 115 may report one or more of the following: a list of supported uplink ranks (e.g., number of supported uplink transmission layers); a list of supported number of SRS antenna ports; and a list of coherence types indicating a subset of ports. In accordance with the second implementation, the network may configure an association between a rank index and rank/number of SRS antenna ports/coherence type. The network may configure/include at least one of the index, the maximum uplink rank, the SRS antenna ports, or coherence type corresponding to a reported SSB resource indicator (SSBRI) and/or CSI-RS resource indicator (CRI) in a beam reporting instance. The second implementation for UE-initiated antenna panel activation and selection may multiple codebook-based SRS resource sets with different number of SRS antenna ports, where the indicated SRI is based on the SRS resources corresponding to one SRS resource set, and where the SRS resource set may be aligned with the UE-reported information corresponding to the index.

In some implementations for UE-initiated antenna panel activation and selection, a UE 115 may report a list of UE 115 capability value sets, where each UE 115 capability value set is associated with (e.g., includes) at least the maximum supported number of SRS ports. In particular, a UE 115 may report a capability for each antenna panel at the UE 115, where the capability for each antenna panel indicates the maximum number of SRS ports which are supported by the respective antenna panel. Capability value sets reported by the UE 115 may include additional parameters, such as indications of supported BWPs or component carriers in a same band or component carrier (e.g., indicates whether the UE capability value set can be common across all BWPs/component carriers). In some cases, no two capability value sets may have identical entries. The correspondence between each reported CSI-RS and/or SRI and one of the UE 115 capability value sets may be determined by the UE 115 and reported to the network in a beam reporting instance (e.g., via a CSI-RS report or other measurement report). In this regard, the index of each corresponding UE 115 capability value set may be reported along with the pair of SSBRI/CRI and Layer one (L1) reference signal received power (RSRP)/SINR (e.g., up to four pairs, with 7-bit absolute and 4-bit differential) in the beam reporting uplink control information (UCI). As such, upon reporting a supported quantity of SRS ports (e.g., via a capability value set), a UE 115 may assume that the correspondence report is activated from the time instance of the reporting. Such techniques may support a codebook of SRS resource sets with different numbers of SRS ports for different SRS resources.

As noted previously herein, some wireless communications systems may allow a UE 115 to report a beam report corresponding to different uplink antenna panels or UE capabilities for antenna panel selection. Some wireless communications systems only enable UEs 115 to be configured with a single SRS resource set for codebook and non-codebook MIMO communications in single transmission-reception point (sTRP) operation. Comparatively, other wireless communications systems may enable UEs 115 to be configured with two or more SRS resource sets of the same SRS ports/resources for codebook and non-codebook based MIMO communications in multiple TRP (mTRP) operation. In cases where the UE may be configured with multiple SRS resource sets, it may be unclear which antenna panel, and which SRS resource set, should be used for transmitting SRSs. In other words, using conventional techniques for antenna panel activation and selection, it may be unclear as to how UEs 115 are to configure and indicate SRS resource sets for fast, efficient uplink antenna panel selection.

Accordingly, the UE 115-a and the base station 105-a of the wireless communications system 100 may support signaling and configurations which enable the UE 115-a to be configured with multiple SRS sets which enable the UE 115-a to identify which antenna panels and SRS sets will be used to transmit SRSs. In this regard, the wireless communications system 200 may support signaling and configurations which enable the UE 115-a to quickly and efficiently identify SRS sets/SRS resource lists, and corresponding antenna panels, which will be used to transmit SRSs. In this regard, techniques described herein may enable fast uplink antenna panel selection for multi-panel UEs 115.

For example, the UE 115-a may transmit capability signaling 215 to the base station 105-a. In some aspects, the capability signaling 215 may indicate a quantity of SRS ports supported by each respective antenna panel 210 at the UE 115-a for MIMO uplink transmission. For example, in cases where the UE 115-a includes a first antenna panel 210-a and second antenna panel 210-b, the capability signaling 215 may indicate that the first antenna panel 210-a supports up to two SRS ports for codebook based MIMO uplink transmission, and that the second antenna panel 210-b supports up to four SRS ports for codebook based MIMO uplink transmission. Supported quantities of SRS ports for each respective antenna panel 210 may be indicated via UE capability values/value sets. In this regard, the UE 115-a may report a list of UE capability value sets including different maximum supported numbers of SRS ports/resources.

In some aspects, the UE 115-a may receive, from the base station 105-a, control signaling 220-a (e.g., RRC signaling, SIB message) which indicates an SRS configuration for the UE 115-a. The UE 115-a may receive the control signaling 220-a based on (e.g., in response to) the capability signaling 215. In some aspects, the SRS configuration may include multiple SRS sets and/or multiple SRS resource lists for codebook or non-codebook based MIMO communications which are each associated with different quantities of SRS ports/resources. In other words, the SRS configuration may include multiple SRS sets and/or multiple SRS resource lists, where each SRS set/SRS resource list may accommodate different maximum numbers of SRS ports/resources. For example, the SRS configuration indicated via the control signaling 220-a may include a first SRS set and a second SRS set for codebook based MIMO uplink transmission, where the first SRS set includes SRS resources of two SRS ports and the second SRS set includes SRS resources of four SRS ports. By way of another example, the SRS configuration indicated via the control signaling 220-a may indicates an SRS resource set for codebook based MIMO uplink transmission which includes a first SRS resource list and a second SRS resource list, where the first SRS resource list includes SRS resources of two SRS ports and second the SRS resource list includes SRS resources of four SRS ports.

In cases where the SRS configuration includes multiple SRS sets which support different maximum quantities of SRS ports, only one of the configured SRS sets from the multiple SRS sets may be active at any one time. That is, the UE 115-a may be configured or indicated with a single active SRS set at a time for codebook or non-codebook based MIMO communications. In some cases, one or more SRS sets may exceed a UE capability reported in a beam reporting instance (e.g., measurement instance 225). That is, in some cases, an SRS set may exceed a capability of the UE 115-a which was reported via the capability signaling 215. For example, the UE 115-a may support only up to four SRS ports for codebook based MIMO communications across the antenna panels 210 at the UE 115-a, and the SRS configuration may include an SRS set which supports up to six SRS ports. In some aspects, different SRS sets included within the SRS configuration may have the same or different SRS set parameters, including unified TCI states, power control parameters, transmission periodicities, corresponding CSI-RSs for the respective SRS sets (e.g., CSI-RS associated with the respective SRS set when the SRS set is for non-codebook based MIMO), aperiodic triggers (e.g., aperiodicSRS-ResourceTrigger), offsets (e.g., slot-offset if respective SRS set is aperiodic), and the like.

Similarly, in cases where the SRS configuration indicated via the control signaling 220-a includes multiple SRS resource lists which support different maximum quantities of SRS ports, only one of the configured SRS resource lists from the multiple SRS resource lists may be active at any one time. That is, the UE 115-a may be configured or indicated with a single active SRS resource list at a time for codebook or non-codebook based MIMO communications. In some aspects, different SRS resource lists included within the SRS configuration may have the same SRS set parameters. In other words, in case where the SRS configuration indicated via the control signaling 220-a includes multiple SRS resource lists, each SRS resource list may include the same SRS parameters (e.g., same unified TCI states, power control parameters, periodicities, corresponding CSI-RSs, aperiodic triggers, offsets, etc.).

In some cases, the UE 115-a may be configured with multiple SRS sets and/or multiple SRS resource lists on a per-BWP and/or per-component carrier basis. In other words, in some implementations, an SRS configuration may include different sets of SRS sets/SRS resource lists for each respective BWP/component carrier. Additionally, or alternatively, the UE 115-a may be configured with different SRS configurations for different component carriers. For example, in some cases, the UE 115-a may receive control signaling 220-a which indicates a first SRS configuration for a first BWP and/or first component carrier, and a second SRS configuration for a second BWP and/or second component carrier. In this regard, the UE 115-a may be configured to communicate in accordance with different SRS configurations depending on the respective BWP/component carrier being used.

In some implementations, the UE 115-a may determine a quantity of SRS ports supported at the UE 115-a via a measurement instance 225. In some aspects, each measurement instance 225 may include a downlink reference signal transmitted by the base station 105-a and a measurement report transmitted by the UE 115-a in response to the downlink reference signal. For example, as shown in the first measurement instance 225-a, the UE 115-a may receive a downlink reference signal (e.g., CSI-RS) from the base station 105-a. In some aspects, the UE 115-a may receive (and the base station 105-a may transmit) the downlink reference signal within the first measurement instance 225-a based on transmitting/receiving the capability signaling 215, transmitting/receiving the control signaling 220-a indicating the SRS configuration, or both.

In some aspects, the downlink reference signal of the measurement instance 225-a may be used by the UE 115-a to estimate channel conditions, and to determine a quantity of SRS ports that the UE 115-a may support with communications between the UE 115-a and the base station 105-a. In this regard, the UE 115-a may be configured to perform one or more measurements (e.g., RSRP, RSRQ, RSSI, CQI, SNR, SINR) on the received downlink reference signal, and may determine a quantity of SRS ports which may be supported at the UE 115-a (at each respective antenna panel 210) based on the performed measurements. For instance, the UE 115-a may be able to support up to four SRS ports with a given antenna panel 210, but the UE 115-a may determine that it is only able to support a maximum of two SRS ports based on the channel conditions determined based on the downlink reference signals received during the first measurement instance 225-a.

The UE 115-a may transmit a measurement report (e.g., CSI-RS report) to the base station 105-a during the first measurement instance 225-a, where the measurement report indicates a quantity of SRS ports that the UE 115-a may support. The UE 115-a may transmit the measurement report to the base station 105-a based on transmitting the capability signaling 215, receiving the control signaling 220-a including the SRS configuration, receiving the reference signal during the first measurement instance 225-a, or any combination thereof. In particular, the measurement report may be based on (e.g., indicate) the measurements performed on the reference signal of the first measurement instance 225-a. In this regard, the measurement report may be associated with measurements performed on signals exchanged via a channel between the UE 115-a and the base station 105-a.

For example, the UE 115-a may determine a quantity of SRS ports the UE 115-a may support based on the reference signal received during the first measurement instance 225-a, and may indicate the supported quantity of SRS ports via the measurement report of the first measurement instance 225-a. In some cases, the quantity of SRS ports indicated via the measurement report may correspond to a quantity of SRS supports supported via an SRS set/SRS resource list configured via the SRS configuration indicated via the control signaling 220-a. For example, in cases where the SRS configuration includes a first SRS set that supports two SRS ports and a second SRS configuration that supports four SRS ports, the measurement report may indicate that the UE 115-a is capable of supporting two or four SRS ports. In this regard, the measurement report may indicate that the UE 115-a is capable of communicating in accordance with one of the first or second SRS sets included within the SRS configuration.

In some aspects, the UE 115-a may receive, from the base station 105-a, additional control signaling 220-b including an activation or indication of an SRS set and/or SRS resource list included within the SRS configuration. In this regard, the UE 115-a may receive an indication/activation of an SRS set and/or SRS resource indication which will be used for transmitting SRSs to the base station 105-a. The UE 115-a may receive the additional control signaling 220-b activating/indicating the SRS set from multiple configured SRS sets or the SRS resource list from multiple SRS resource lists configured for an SRS set based on transmitting the capability signaling 215, receiving the control signaling 220-a including the SRS configuration, receiving the reference signal of the first measurement instance 225-a, transmitting the measurement report of the first measurement instance 225-a, or any combination thereof. The additional control signaling 220-b which provides the indication/activation of the respective SRS set and/or SRS resource list may include a DCI message, a MAC-CE message, an RRC reconfiguration message, or any combination thereof.

For example, in cases where the UE 115-a indicates (via the measurement report of the first measurement instance 225-a) that it is capable of supporting up to two SRS ports, the UE 115-a may receive an SRS set update indication via the additional control signaling 220-b which indicates or activates an SRS set included within the SRS configuration. In particular, the additional control signaling 220-b may indicate an SRS set which supports up to two SRS ports based on the quantity of SRS ports supported at the UE 115-a. By way of another example, the UE 115-a may receive an SRS activation MAC-CE (e.g., control signaling 220-b) which indicates/activates an SRS set included within the SRS configuration.

In some aspects, the indication/activation of the respective SRS set/SRS resource list may be associated with one or more bit fields of the additional control signaling 220-b (e.g., bit fields of DCI), including an SRI field, a TPMI field, or both. In particular, the antenna port number, the DCI field length, and the codepoint mapping, or any combination thereof, for one or more SRI fields, one or more TPMI fields may be based on the active SRS configuration. In some implementations, the UE 115-a may determine the indicated/activated SRS set/SRS resource list based on the DCI field length, codepoint mapping, based on the active SRS configuration (e.g., SRS configuration indicated/activated via the control signaling 220-a). For example, when the active SRS configuration includes SRS resources of four ports, the TPMI field may include six bits, and when the active SRS configuration includes SRS resources of two ports, the TPMI field may include four bits. Further, a MAC-CE message may indicate/activate the respective SRS set/SRS resource list by indicating a UE capability identifier (e.g., UE capability value set identifier), an SRS set identifier, an SRS resource list identifier, or any combination thereof.

In some aspects, the UE 115-a may select an antenna panel 210 from the multiple antenna panels 210 at the UE 115-a which will be used for wireless communications with the base station 105-a. The UE 115-a may select the antenna panel 210 based on transmitting the capability signaling 215, receiving the control signaling 220-a indicating the SRS configuration, receiving the downlink reference signal of the first measurement instance 225-a, transmitting the measurement report of the first measurement instance 225-a, receiving the additional control signaling 220-b including the indication/activation of the SRS set/SRS resource list, or any combination thereof.

In some aspects, the UE 115-a may select the antenna panel 210 based on the quantity of SRS ports supported at the UE 115-a, as indicated via the measurement report of the first measurement instance 225-a. In particular, the UE 115-a may select an antenna panel 210 which corresponds the quantity of SRS ports able to be supported between the UE 115-a and the base station 105-a, and/or corresponds to the indicated/activated SRS set/SRS resource list. For example, the UE 115-a may indicate that it is able to support up to four SRS ports via the measurement report of the first measurement instance 225-a, and the base station 105-a may indicate/activate an SRS resource list which supports four SRS ports via the additional control signaling 220-b. In this example, the UE 115-a may select an antenna panel 210 at the UE 115-a which supports four SRS ports.

In some implementations, the UE 115-a may transmit a feedback message 230-a (e.g., ACK/NACK message) to the base station 105-a. In some aspects, the UE 115-a may transmit the feedback message 230-a in response to receiving the additional control signaling 220-b which provides the indication/activation of the SRS set/SRS resource list. In this regard, the feedback message 230-a may serve as an acknowledgement of the SRS set and/or SRS resource list which was indicated/activated via the additional control signaling 220-b.

In some aspects, the SRS set and/or SRS resource list indicated via the additional control signaling 220-b may become activated some time interval 235 after receiving the additional control signaling 220-b and/or transmitting the feedback message 230-a. In other words, the UE 11-b may begin transmitting SRSs 240 in accordance with the indicated/activated SRS set/SRS resource list some time interval 235 after receiving the additional control signaling 220-b indicating the SRS indication/activation and/or some time interval 235 after transmitting the feedback message 230-a.

For example, as shown in FIG. 2, the indicated SRS set/SRS resource list may become activated some time interval 235-a after transmitting the feedback message 230-a, such that an active duration 245 for the activated SRS set/SRS resource list begins after the end of the time interval 235-a. In some implementations, the time interval 235-a for activation of the indicated SRS set/SRS resource list may be 3 ms. In other words, the UE 115-a may begin transmitting SRSs 240 in accordance with the activated SRS set/SRS resource list 3 ms after transmitting the feedback message 230-a.

In some aspects, the UE 115-a may receive, from the base station 105-a, a request for an SRS 240. In some cases, the UE 115-a may receive (and the base station 105-a may transmit) the SRS request based on transmitting/receiving additional control signaling 220-b indicating/activating an SRS set/SRS resource list, transmitting/receiving the feedback message 230-a, or both. For example, the base station 105-a may transmit a DCI message or MAC-CE message including a request for an SRS 240 in response to the feedback message 230-a. In some aspects, the SRS request may include an allocation of resources which will be used for transmitting the requested SRS 240.

In some aspects, the SRS request may be transmitted/received some time interval 235-a (e.g., Y ms) after transmission of the feedback message 230-a. For instance, the additional control signaling 220-b providing the SRS indication/activation may include a DCI message including an enhanced TCI indication. In this example, the TCI codepoint in the DCI message (and/or a dedicated field the DCI message) may indicate the indicated/activated SRS set/SRS resource list via a UE capability identifier, an SRS set identifier, an SRS resource list identifier, or any combination thereof, and the SRS set/SRS resource list may become activated after time interval 235-a following the ACK (e.g., feedback message 230-a) to the DCI message. In this example, the active duration 245 for the activated SRS set/SRS resource list may begin after an end of the time interval 235-a (e.g., after Y ms following the feedback message 230-a).

By way of another example, the SRS request may include an enhanced SRS request DCI message for aperiodic SRS sets. For example, the UE 115-a may receive a DCI message including an SRS request field which jointly indicates an A-SRS trigger identifier and an SRS set identifier/SRS resource list identifier. Additionally, or alternatively, the DCI message may include an SRS request field and dedicated fields for indicating the respective activated SRS set/SRS resource list.

In some aspects, the UE 115-a may transmit a first SRS 240-a (e.g., a first set of SRSs 240-a) to the base station 105-a. In particular, the UE 115-a may transmit the first SRS 240-a in accordance with the SRS configuration indicated via the control signaling 220-a, and in accordance with the quantity of SRS ports supported by the UE 115-a, as indicated via the measurement report of the first measurement instance 225-a. In this regard, the UE 115-a may transmit the first SRS 240-a based on transmitting the capability signaling 215, receiving the control signaling 220-a including the SRS configuration, receiving the reference signal of the first measurement instance 225-a, transmitting the measurement report of the first measurement instance 225-a, receiving the control signaling 220-b indicating/activating the SRS set/SRS resource list, selecting the antenna panel 210, transmitting the feedback message 230-a, receiving the SRS request, or any combination thereof. For example, the UE 115-a may transmit the first SRS 240-a using the selected antenna panel 210 and in response to a received SRS request at 340.

The UE 115-a may transmit the first SRS 240-a in accordance with the SRS configuration. In particular, the UE 115-a may transmit the first SRS 240-a in accordance with the activated SRS set and/or activated SRS resource list included within the SRS configuration. For example, the SRS configuration may include a first SRS set that supports two SRS ports and a second SRS set that supports four SRS ports. In this example, the UE 115-a may indicate that it may support up to two SRS ports via the measurement report of the first measurement instance 225-a. Accordingly, in this example, the base station 105-a may activate the first SRS set that supports two SRS ports via the control signaling 220-b, and the UE 115-a may transmit the first SRS 240-a in accordance with the first SRS set (e.g., in accordance with an antenna panel 210 that supports two SRS ports). In this regard, the UE 115-a may be configured to transmit the SRS 240-a in accordance with an SRS set/SRS resource list which corresponds to the indicated quantity of SRS ports which are supported by the UE 115-a (as indicated via the measurement report of the measurement instance 225-a).

In some aspects, the UE 115-a may transmit the first SRS 240-a (e.g., first set of SRSs 240-a) in accordance with a periodicity. For example, in some cases, the control signaling 220-a may indicate one or more periodicities associated with the SRS configuration. In such cases, the UE 115-a may transmit the first SRS 240-a in accordance with a periodicity associated with the SRS configuration.

In some cases, the UE 115-a and the base station 105-a may continually or periodically evaluate a quantity of SRS ports which are capable of being supported at the UE 115-a by exchanging reference signals, for example, during subsequent measurement instances 225. Moreover, the base station 105-a and the UE 115-a may be configured to dynamically change/update the SRS set/SRS resource configuration (and therefore the quantity of supported SRS ports) based on changing channel conditions and changing capabilities at the UE 115-a.

For example, the UE 115-a may receive a downlink reference signal (e.g., CSI-RS) from the base station 105-a during a second measurement instance 225-b. As noted previously herein with reference to the reference signal of the first measurement instance 225-a, the reference signal may be used to evaluate channel conditions between the UE 115-a and the base station 105-a, and to determine a quantity of SRS ports supported at the UE 115-a. As such, any description associated with the first measurement instance 225-a may be regarded as applying to the second measurement instance 225-b, unless noted otherwise herein.

Continuing with reference to the second measurement instance 225-b, the UE 115-a may transmit a measurement report (e.g., CSI-RS report) to the base station 105-a, where the measurement report indicates a quantity of SRS ports that the UE 115-a may support. The UE 115-a may transmit the measurement report to the base station 105-a based on measurements performed on the reference signal received during the second measurement instance 225-b. In this regard, the measurement report may be associated with measurements performed on signals exchanged via a channel between the UE 115-a and the base station 105-a. In other words, the UE 115-a may transmit a measurement report which updates the supported quantity of SRS ports supported at the UE 115-a as compared to the quantity of supported SRS ports indicated via the measurement report of the first measurement instance 225-a.

In some aspects, the UE 115-a may receive, from the base station 105-a, additional control signaling 220-c including an activation or indication of an SRS set and/or SRS resource list included within the SRS configuration. In this regard, the UE 115-a may receive an indication/activation of an SRS set and/or SRS resource indication which will be used for transmitting additional SRSs 240 to the base station 105-a. The UE 115-a may receive the additional control signaling 220-c activating/indicating the SRS set/SRS resource list based on receiving the reference signal during the second measurement instance 225-b, transmitting the measurement report during the second measurement instance 225-b, or both. For example, the control signaling 220-c may indicate/activate an SRS set/SRS resource list which supports a quantity of SRS ports that corresponds to the quantity of SRS ports supported by the UE 115-a which were indicated via the measurement report of the second measurement instance 225-b. The additional control signaling 220-c which provides the indication/activation of the respective SRS set and/or SRS resource list may include a DCI message, a MAC-CE message, an RRC reconfiguration message, or any combination thereof.

In general, the network may utilize the control signaling 220-c to dynamically update the SRS set/SRS resource list used for codebook and non-codebook based communications, and for fast uplink antenna panel 210 selection at the UE 115-a. In cases where the control signaling 220-c includes a DCI message, the UE 115-a may determine SRI fields, TPMI fields, or both in the DCI message based on the active SRS set or active SRS resource list. For example, the SRI fields and/or TPMI fields, field length, and codepoint mapping may be based on the active SRS configuration.

In some cases, the SRS set/SRS resource list at the UE 115-a may be dynamically updated via dedicated signaling. For example, a dedicated MAC-CE message (e.g., control signaling 220-c) may indicate the update of the active SRS set/SRS resource list configured for codebook and non-codebook based MIMO communications. This dynamic update may be applied to periodic, semi-persistent, and aperiodic active SRS sets/SRS resource lists. In some cases, the MAC-CE message may indicate the new SRS set/SRS resource list (e.g., indicate the update to the SRS set/SRS resource list) by indicating a UE capability value set identifier, an SRS set identifier, an SRS resource list identifier, or any combination thereof. To improve reliability, and as described previously herein, the UE 115-a may update then active SRS set/SRS resource list some time interval 235 (e.g., 3 ms) after the MAC-CE message (e.g., control signaling 220-c), and/or some time interval 235-b after a feedback message 230-b (e.g., ACK) responsive to the MAC-CE message.

In cases where the SRS configuration includes multiple SRS sets corresponding to different maximum numbers of supported SRS sets, only the indicated SRS set may be active for codebook/non-codebook communications at any one time, where all other SRS sets are inactive or suspended. Accordingly, in some cases, the control signaling 220-c may activate the new SRS set and deactivate the old SRS set, where explicit signaling for deactivation/suspension of the old SRS set may not be necessary. Conversely in other cases, additional control signaling 220 may deactivate the old SRS set, and the control signaling 220-c may serve to activate the new SRS set. Comparatively, in cases where the SRS configuration includes multiple SRS resource lists corresponding to different maximum numbers of supported SRS sets, only the indicated SRS resource list may be active for codebook/non-codebook communications at any one time, and all other SRS resource lists are inactive and not used. As such, in cases where the SRS configuration includes multiple SRS resource lists, explicit deactivation signaling for the old SRS resource list may not be necessary.

In additional or alternative implementations, the control signaling 220-c used to dynamically update the SRS set/SRS resource list may include legacy SRS indication signaling. For example, the control signaling 220-c may include an RRC reconfiguration message that indicates an update to a periodic SRS set for codebook and non-codebook based MIMO communications. By way of another example, the control signaling 220-c may include MAC-CE signaling to deactivate the old SRS set and activate the new SRS set, or DCI signaling to trigger a different SRS set. In cases where the control signaling 220-c includes legacy SRS indication signaling, additional signaling for explicit deactivation/suspension of the old SRS set/old SRS resource list may be needed. For example, the additional control signaling 220-c may include a first MAC-CE which deactivates the first SRS set used to transmit the first SRS 240-a, and a second MAC-CE which activates a second SRS set which will be used to transmit subsequent SRSs 240-b.

In some implementations, existing signaling may be enhanced to indicate the update for the SRS set/SRS resource list for the UE 115-a. For example, in some cases, the control signaling 220-c providing the dynamic SRS update may include an enhanced TCI activation MAC-CE message. In this example, the MAC-CE message may indicate the updated SRS set/SRS resource list via a UE capability value set identifier, an SRS set identifier, or an SRS resource list identifier, where the UE 115-a uses the respective identifier in the MAC-CE message to identify/select the new active SRS set/SRS resource list. In this example, the information in the MAC-CE message indicating the SRS update may be included or associated with a TCI state (e.g., via RRC signaling), or included in the MAC-CE and indicated together with activated TCI states. As noted previously, in the context of enhanced TCI activation MAC-CE messages, the UE 115-a may be configured to update the SRS set/SRS resource list some time interval 235 (e.g., 3 ms) after the MAC-CE message and/or some time interval 235-b after a feedback message 230-b (e.g., ACK) for the MAC-CE message. The new; updated SRS set/SRS resource list may be applied to the first SRS transmission occasion if the SRS is periodic or semi-persistent, or to the first triggered SRS scheduling if the SRS is aperiodic (some time interval 235-b after the ACK).

By way of another example, the dynamic update to the SRS set/SRS resource list provided via the control signaling 220-c may be indicated by an enhanced TCI indication DCI message. In such cases, the TCI codepoint in DCI message (or dedicated field in the DCI message) may be used to indicate the updated SRS set/SRS resource list via a UE capability value set identifier, an SRS set identifier, or an SRS resource list identifier. Once again, the UE 115-a may be configured to update the SRS set/SRS resource list some time interval 235 (e.g., Y ms) after the DCI message (e.g., control signaling 220-c), and/or some time interval 235-b after a feedback message 230-b (e.g., ACK) responsive to the DCI message. By way of another example, the dynamic update to the SRS set/SRS resource list at 360 may be indicated by an enhanced SRS-request DCI message, such as in the context of aperiodic SRS sets. In this example, an SRS request field in the SRS-request DCI message may be enhanced to jointly indicate an aperiodic SRS trigger identifier and an SRS set indicator/SRS resource list indicator. Additionally, or alternatively, an SRS-request DCI message may indicate the SRS update via an SRS request field and dedicated SRS set field/SRS resource list field.

In some aspects, the UE 115-a may select an antenna panel 210 from the multiple antenna panels 210 at the UE 115-a which will be used for wireless communications with the base station 105-a. The UE 115-a may select the antenna panel 210 based on receiving the additional control signaling 220-c including the indication/activation of the SRS set/SRS resource list. In this regard, the UE 115-a may select the antenna panel 210 based on the dynamic update to the SRS set/SRS resource list indicated via the control signaling 220-c. A

In some cases, the UE 115-a may transmit a feedback message 230-b (e.g., HARQ-ACK/NACK message) to the base station 105-a. In some aspects, the UE 115-a may transmit the feedback message 230-b in response to receiving the additional control signaling 220-c which provides the dynamic update of the SRS set/SRS resource list. In this regard, the feedback message 230-b may serve as an acknowledgement of the SRS set and/or SRS resource list which was indicated/activated via the control signaling 220-c. Moreover, as described previously herein, in some implementations, the UE 115-a may be configured to update the SRS set/SRS resource list some time interval 235-b (e.g., 3 ms, Y ms) after transmitting the feedback message 230-b responsive to the dynamic SRS update received via the control signaling 220-c. In this regard, any discussion regarding the feedback message 230-a (and corresponding SRS activation following the feedback message 230-a) may be regarded as applying to the feedback message 230-b, unless noted otherwise herein.

In some implementations, the UE 115-a may receive, from the base station 105-a, a request for an SRS 240-b. In some cases, the UE 115-a may receive (and the base station 105-a may transmit) the SRS request based on transmitting/receiving additional control signaling 220-c indicating/activating an SRS set/SRS resource list, transmitting/receiving the feedback message 230-b, or both. For example, the base station 105-a may transmit a DCI message or MAC-CE message including a request for an SRS 240-b in response to the feedback message 230-b. In some aspects, the SRS request may include an allocation of resources which will be used for transmitting the requested SRS 240-b.

The UE 115-a may transmit a second SRS 240-b (e.g., a second set of SRSs 240-b) to the base station 105-a. In particular, the UE 115-a may transmit the second SRS 240-b in accordance with the SRS configuration indicated via the control signaling 220-a, and in accordance with the quantity of SRS ports supported by the UE 115-a, as indicated via the measurement report of the second measurement instance 225-b. For example, the UE 115-a may transmit the second SRS 240-b using the selected antenna panel 210 and in response to a received SRS request. The UE 115-a may transmit the second SRS 240-b in accordance with the SRS configuration. In particular, the UE 115-a may transmit the second SRS 240-b in accordance with the SRS update received via the control signaling 220-d.

Techniques described herein may support signaling and configurations which enable UEs 115 to quickly and efficiently identify SRS sets/SRS resource lists, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of layers/SRS ports, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system 200.

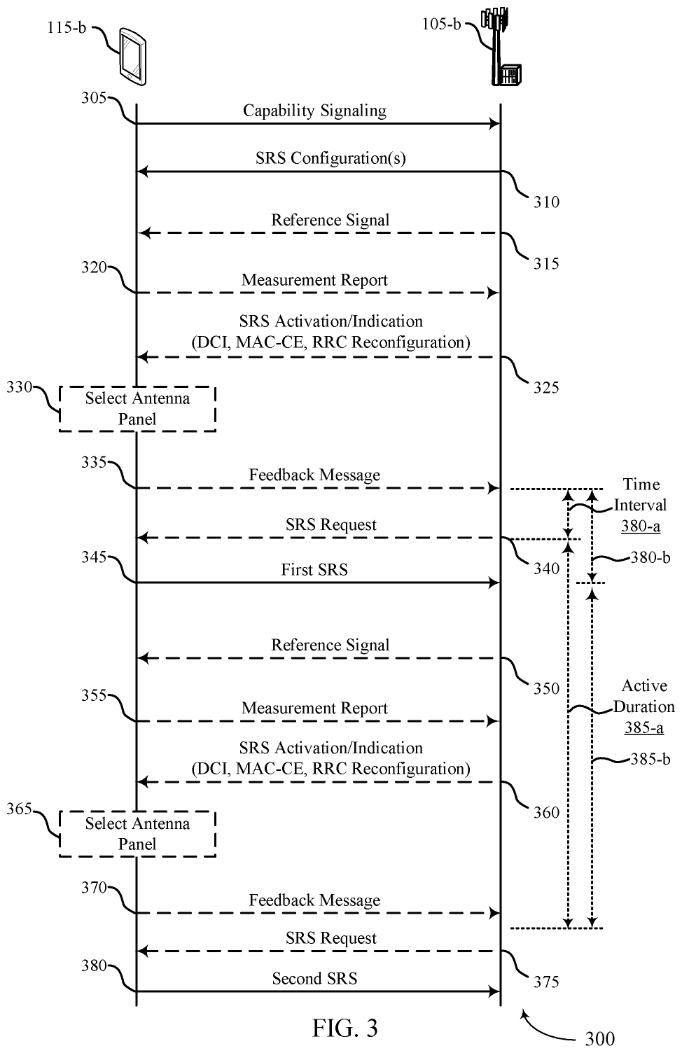

FIG. 3 illustrates an example of a process flow 300 that supports techniques for SRS configurations for uplink panel selection in accordance with aspects of the present disclosure. In some examples, process flow 300 may implement, or be implemented by, aspects of wireless communications system 100, wireless communications system 200, or both. For example, the process flow 300 may illustrate a UE 115-b receiving transmitting UE capability signaling indicating capabilities of antenna panels at the UE 115-b, receiving an SRS configuration, and transmitting SRSs in accordance with the UE capabilities and the SRS configuration, as described with reference to FIGS. 1 and 2.

In some cases, process flow 300 may include a UE 115-b and a base station 105-b, which may be examples of corresponding devices as described herein. In particular, the UE 115-b and the base station 105-b illustrated in FIG. 3 may include examples of the UE 115-a and the base station 105-a, respectively, as illustrated in FIG. 2.

In some examples, the operations illustrated in process flow 300 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below; or further steps may be added.

At 305, the UE 115-b may transmit capability signaling to the base station 105-b. In some aspects, the capability signaling may indicate a quantity of SRS ports supported by each respective antenna panel at the UE 115-b. For example, in cases where the UE 115-b includes a first and second antenna panel, the capability signaling may indicate that the first antenna panel supports up to two SRS ports, and that the second antenna panel supports up to four SRS ports. Supported quantities of SRS ports for each respective antenna port may be indicated via UE capability values/value sets. In this regard, the UE 115-b may report a list of UE capability value sets including different maximum supported numbers of SRS ports/resources.

At 310, the UE 115-b may receive, from the base station 105-b, control signaling (e.g., RRC signaling, SIB message) which indicates an SRS configuration for the UE 115-b. The UE 115-b may receive the control signaling based on (e.g., in response to) the capability signaling at 305. In some aspects, the SRS configuration may include multiple SRS sets and/or multiple SRS resource lists for codebook and non-codebook based MIMO communications which are each associated with different quantities of SRS ports/resources. In other words, the SRS configuration may include multiple SRS sets and/or multiple SRS resource lists, where each SRS set/SRS resource list may accommodate different maximum numbers of SRS ports/resources. For example, the SRS configuration indicated via the control signaling at 310 may include a first SRS set and a second SRS set, where the first SRS set includes two SRS ports and second the SRS set includes four SRS ports. By way of another example, the SRS configuration indicated via the control signaling at 310 may include a first SRS resource list and a second SRS resource list, where the first SRS resource list includes two SRS ports and second the SRS resource list includes four SRS ports.

In cases where the SRS configuration includes multiple SRS sets which support different maximum quantities of SRS ports, only one of the configured SRS sets from the multiple SRS sets may be active at any one time. That is, the UE 115-b may be configured with a single active SRS set at a time for codebook and non-codebook based MIMO communications. In some cases, one or more SRS sets may exceed a UE capability reported in a beam reporting instance. That is, in some cases, an SRS set may exceed a capability of the UE 115-b which was reported via the capability signaling at 305. For example, the UE 115-b may support only up to four SRS ports across the antenna panels at the UE 115-b, and the SRS configuration may include an SRS set which supports up to six SRS ports. In some aspects, different SRS sets included within the SRS configuration may have the same or different SRS set parameters, including unified TCI states, power control parameters, path loss reference signals, periodicities, corresponding CSI-RSs for the respective SRS sets (e.g., CSI-RS corresponding to the respective SRS set when the SRS set is for non-codebook based MIMO), aperiodic triggers (e.g., aperiodicSRS-ResourceTrigger), offsets (e.g., slot-offset if respective SRS set is aperiodic), and the like.

An example SRS configuration that includes multiple SRS sets which support different maximum quantities of SRS ports may be further shown with respect to the data object below:

```
SRS-ResourceSet1 ::= SEQUENCE {
  srs-ResourceSetId
  srsResourceIdList
  usage ENUMERATED {codebook},
  alpha
  p0
  pathlossReferenceRS
  ...
}
SRS-ResourceSet2 ::= SEQUENCE {
  srs-ResourceSetId
  srsResourceIdList
  usage ENUMERATED {codebook},
  alpha
  p0
  pathlossReferenceRS
  ...
}
```

where SRS-ResourceSet1 includes a first SRS set that supports a first quantity of SRS ports, and SRS-ResourceSet2 includes a second SRS set that supports a second quantity of SRS ports. Moreover, as noted previously herein, the SRS parameters alpha, p0, and pathlossReferenceRS may be the same or different across the respective SRS sets.

Similarly, in cases where the SRS configuration includes multiple SRS resource lists which support different maximum quantities of SRS ports, only one of the configured SRS resource lists from the multiple SRS resource lists may be active at any one time. That is, the UE 115-b may be configured with a single active SRS resource list at a time for codebook and non-codebook based MIMO communications. In some aspects, different SRS resource lists included within the SRS configuration may have the same SRS set parameters. In other words, in case where the SRS configuration indicated at 310 includes multiple SRS resource lists, each SRS resource list may include the same SRS parameters (e.g., same unified TCI states, power control parameters, periodicities, corresponding CSI-RSs, aperiodic triggers, offsets, etc.).

An example SRS configuration that includes multiple SRS resource lists which support different maximum quantities of SRS ports may be further shown with respect to the data object below:

```
SRS-ResourceSet ::= SEQUENCE {
  srs-ResourceSetId
  srsResourceIdList1,
  srsResourceIdList2,
  usage ENUMERATED {codebook},
  alpha
  p0
  pathlossReferenceRS
  ...
}
```

where the SRS-ResourceSet includes two separate SRS resource lists (e.g., srs-ResourceIdList1, srs-ResourceIdList2). Moreover, as noted previously herein, the SRS parameters alpha, p0, and pathlossReferenceRS may be the same across the respective SRS resource lists.

In some cases, the UE 115-b may be configured with multiple SRS sets and/or multiple SRS resource lists on a per-BWP or per-component carrier basis. In other words, in some implementations, an SRS configuration may include different sets of SRS sets/SRS resource lists for each respective BWP/component carrier. Additionally, or alternatively, the UE 115-b may be configured with different SRS configurations for different component carriers. For example, in some cases, the UE 115-b may receive control signaling which indicates a first SRS configuration for a first BWP and/or first component carrier, and a second SRS configuration for a second BWP and/or second component carrier. In this regard, the UE 115-b may be configured to communicate in accordance with different SRS configurations depending on the respective BWP/component carrier being used.

At 315, the UE 115-b may receive a downlink reference signal (e.g., CSI-RS) from the base station 105-b. In some aspects, the UE 115-b may receive (and the base station 105-b may transmit) the downlink reference signal at 315 based on transmitting/receiving the capability signaling at 305, transmitting/receiving the control signaling indicating the SRS configuration at 310, or both.

In some aspects, the downlink reference signal may be used by the UE 115-b to estimate channel conditions, and to determine a quantity of SRS ports that the UE 115-b may support with communications between the UE 115-b and the base station 105-b. In this regard, the UE 115-b may be configured to perform one or more measurements (e.g., RSRP, RSRQ, RSSI, CQI, SNR, SINR) on the received downlink reference signal, and may determine a quantity of SRS ports which may be supported at the UE 115-b (at each respective antenna panel) based on the performed measurements. For instance, the UE 115-b may be able to support up to four SRS ports with a given antenna panel, but the UE 115-b may determine that it is only able to support a maximum of two SRS ports based on the channel conditions determined based on the downlink reference signals.

At 320, the UE 115-b may transmit a measurement report (e.g., CSI-RS report) to the base station 105-b, where the measurement report indicates a quantity of SRS ports that the UE 115-b may support. The UE 115-b may transmit the measurement report to the base station 105-b based on transmitting the capability signaling at 305, receiving the control signaling including the SRS configuration at 310, receiving the reference signal at 315, or any combination thereof. In particular, the measurement report may be based on (e.g., indicate) the measurements performed on the reference signal at 315. In this regard, the measurement report may be associated with measurements performed on signals exchanged via a channel between the UE 115-b and the base station 105-b.

For example, the UE 115-b may determine a quantity of SRS ports the UE 115-b may support based on the received reference signal, and may indicate the supported quantity of SRS ports via the measurement report at 320. In some cases, the quantity of SRS ports indicated via the measurement report may correspond to a quantity of SRS supports supported via an SRS set/SRS resource list configured via the SRS configuration at 310. For example, in cases where the SRS configuration includes a first SRS set that supports two SRS ports and a second SRS configuration that supports four SRS ports, the measurement report may indicate that the UE 115-b is capable of supporting two or four SRS ports. In this regard, the measurement report may indicate that the UE 115-b is capable of communicating in accordance with one of the first or second SRS sets included within the SRS configuration.

At 325, the UE 115-b may receive, from the base station 105-b, additional control signaling including an activation or indication of an SRS set and/or SRS resource list included within the SRS configuration. In this regard, the UE 115-b may receive an indication/activation of an SRS set and/or SRS resource indication which will be used for transmitting SRSs to the base station 105-b. The UE 115-b may receive the additional control signaling activating/indicating the SRS set/SRS resource list at 325 based on transmitting the capability signaling at 305, receiving the control signaling including the SRS configuration at 310, receiving the reference signal at 315, transmitting the measurement report at 320, or any combination thereof. The additional control signaling which provides the indication/activation of the respective SRS set and/or SRS resource list at 325 may include a DCI message, a MAC-CE message, an RRC reconfiguration message, or any combination thereof.

For example, in cases where the UE 115-b indicates (via the measurement report) that it is capable of supporting up to two SRS ports, the UE 115-b may receive an SRS set update indication via the additional control signaling at 325 which indicates/activates an SRS set included within the SRS configuration. In particular, the additional control signaling may indicate an SRS set which supports up to two SRS ports based on the quantity of SRS ports supported at the UE 115-b. By way of another example, the UE 115-b may receive an SRS activation MAC-CE which indicates/activates an SRS set included within the SRS configuration. In some aspects, the indication/activation of the respective SRS set/SRS resource list may be indicated via one or more bit fields of the additional control signaling (e.g., bit fields of DCI), including an SRI field, a TPMI field, or both. In some implementations, the UE 115-b may determine the indicated/activated SRS set/SRS resource list based on field length, codepoint mapping, and/or the active SRS configuration (e.g., SRS configuration indicated/activated via the control signaling at 310). Further, a MAC-CE message may indicate/activate the respective SRS set/SRS resource list by indicating a UE capability identifier (e.g., UE capability value set identifier), an SRS set identifier, an SRS resource list identifier, or any combination thereof.

At 330, the UE 115-b may select an antenna panel from the multiple antenna panels at the UE 115-b which will be used for wireless communications with the base station 105-b. The UE 115-b may select the antenna panel at 330 based on transmitting the capability signaling at 305, receiving the control signaling indicating the SRS configuration at 310, receiving the downlink reference signal at 315, transmitting the measurement report at 320, receiving the additional control signaling including the indication/activation of the SRS set/SRS resource list at 325, or any combination thereof.

In some aspects, the UE 115-b may select the antenna panel based on the quantity of SRS ports supported at the UE 115-b, as indicated via the measurement report at 320. In particular, the UE 115-b may select an antenna panel which corresponds the quantity of SRS ports able to be supported between the UE 115-b and the base station 105-b, and/or corresponds to the indicated/activated SRS set/SRS resource list. For example, the UE 115-b may indicate that it is able to support up to four SRS ports via the measurement report at 320, and the base station 105-b may indicate/activate an SRS resource list which supports four SRS ports at 325. In this example, the UE 115-b may select an antenna panel at the UE 115-b which supports four SRS ports.

At 335, the UE 115-b may transmit a feedback message (e.g., HARQ-ACK/NACK message) to the base station 105-b. In some aspects, the UE 115-b may transmit the feedback message in response to receiving the additional control signaling at 325 which provides the indication/activation of the SRS set/SRS resource list. In this regard, the feedback message may serve as an acknowledgement of the SRS set and/or SRS resource list which was indicated/activated at 330.

In some aspects, the SRS set and/or SRS resource list indicated via the additional control signaling at 325 may become activated some time interval 380 after receiving the additional control signaling and/or transmitting the feedback message. In other words, the UE 11-b may begin transmitting SRSs in accordance with the indicated/activated SRS set/SRS resource list some time interval 380 after receiving the SRS indication/activation at 325 and/or some time interval 380 after transmitting the feedback message at 335. For example, as shown in FIG. 3, the indicated SRS set/SRS resource list may become activated some time interval 380-a, 380-b after transmitting the feedback message, such that an active duration 385-a, 385-b for the activated SRS set/SRS resource list begins after the end of the time interval 380. In some implementations, the time interval 380 for activation of the indicated SRS set/SRS resource list may be 3 ms. In other words, the UE 115-b may begin transmitting SRSs in accordance with the activated SRS set/SRS resource list 3 ms after transmitting the feedback message.

At 340, the UE 115-b may receive, from the base station 105-b, a request for an SRS. In some cases, the UE 115-b may receive (and the base station 105-b may transmit) the SRS request at 340 based on transmitting/receiving additional control signaling indicating/activating an SRS set/SRS resource list, transmitting/receiving the feedback message at 335, or both. For example, the base station 105-b may transmit a DCI message or MAC-CE message including a request for an SRS in response to the feedback message. In some aspects, the SRS request may include an allocation of resources which will be used for transmitting the requested SRS.

In some aspects, the SRS request may be transmitted/received some time interval 380-a (e.g., Y ms) after transmission of the acknowledgement message. For instance, the additional control signaling at 325 providing the SRS indication/activation may include a DCI message including an enhanced TCI indication. In this example, the TCI codepoint in the DCI message (and/or a dedicated field the DCI message) may indicate the indicated/activated SRS set/SRS resource list via a UE capability identifier, an SRS set identifier, an SRS resource list identifier, or any combination thereof, and the SRS set/SRS resource list may become activated after time interval 380-a following the ACK (e.g., feedback message) to the DCI message. In this example, the active duration 385-a for the activated SRS set/SRS resource list may begin after an end of the time interval 380-a (e.g., after Y ms following the feedback message).

By way of another example, the SRS request at 340 may include an enhanced SRS request DCI message for aperiodic SRS sets. For example, the UE 115-b may receive a DCI message at 340, where the DCI message includes an SRS request field which jointly indicates an A-SRS trigger identifier and an SRS set identifier/SRS resource list identifier. Additionally, or alternatively, the DCI message may include an SRS request field and dedicated fields for indicating the respective activated SRS set/SRS resource list.

At 345, the UE 115-b may transmit a first SRS (e.g., a first set of SRSs) to the base station 105-b. In particular, the UE 115-b may transmit the first SRS in accordance with the SRS configuration indicated via the control signaling at 310, and in accordance with the quantity of SRS ports supported by the UE 115-b, as indicated via the measurement report at 320. In this regard, the UE 115-b may transmit the first SRS based on transmitting the capability signaling at 305, receiving the control signaling including the SRS configuration at 310, receiving the reference signal at 315, transmitting the measurement report at 320, receiving the control signaling indicating/activating the SRS set/SRS resource list at 325, selecting the antenna panel at 330, transmitting the feedback message at 335, receiving the SRS request at 340, or any combination thereof. For example, the UE 115-b may transmit the first SRS at 345 using the antenna panel selected at 330, and in response to the SRS request at 340.

The UE 115-b may transmit the first SRS in accordance with the SRS configuration. In particular, the UE 115-b may transmit the first SRS in accordance with the activated SRS set and/or activated SRS resource list included within the SRS configuration. For example, the SRS configuration may include a first SRS set that supports two SRS ports and a second SRS set that supports four SRS ports. In this example, the UE 115-b may indicate that it may support up to two SRS ports via the measurement report at 320. Accordingly, in this example, the base station 105-b may activate the first SRS set that supports two SRS ports via the control signaling at 325, and the UE 115-b may transmit the first SRS at 345 in accordance with the first SRS set (e.g., in accordance with an antenna panel that supports two SRS ports). In this regard, the UE 115-b may be configured to transmit the SRS in accordance with an SRS set/SRS resource list which corresponds to the indicated quantity of SRS ports which are supported by the UE 115-b (as indicated via the measurement report).

In some aspects, the UE 115-b may transmit the first SRS (e.g., first set of SRSs) in accordance with a periodicity. For example, in some cases, the control signaling at 310 may indicate one or more periodicities associated with the SRS configuration. In such cases, the UE 115-b may transmit the first SRS in accordance with a periodicity associated with the SRS configuration.

In some cases, the UE 115-b and the base station 105-b may continually or periodically evaluate a quantity of SRS ports which are capable of being supported at the UE 115-b by exchanging reference signals. Moreover, the base station 105-b and the UE 115-b may be configured to dynamically change/update the SRS set/SRS resource configuration (and therefore the quantity of supported SRS ports) based on changing channel conditions and changing capabilities at the UE 115-b. This may be further understood with reference to steps 350-375 of process flow 300.

At 350, the UE 115-b may receive a downlink reference signal (e.g., CSI-RS) from the base station 105-b. As noted previously herein with reference to the reference signal at 315, the reference signal at 350 may be used to evaluate channel conditions between the UE 115-b and the base station 105-b, and to determine a quantity of SRS ports supported at the UE 115-b. As such, any description associated with the reference signal at 315 may be regarded as applying to the reference signal at 350, unless noted otherwise herein.

At 355, the UE 115-b may transmit a measurement report (e.g., CSI-RS report) to the base station 105-b, where the measurement report indicates a quantity of SRS ports that the UE 115-b may support. The UE 115-b may transmit the measurement report to the base station 105-b based on measurements performed on the reference signal at 350. In this regard, the measurement report may be associated with measurements performed on signals exchanged via a channel between the UE 115-b and the base station 105-b. Moreover, any discussion associated with the measurement report at 320 may be regarded as applying to the reference signal at 355, unless noted otherwise herein.

At 360, the UE 115-b may receive, from the base station 105-b, additional control signaling including an activation or indication of an SRS set and/or SRS resource list included within the SRS configuration. In this regard, the UE 115-b may receive an indication/activation of an SRS set and/or SRS resource indication which will be used for transmitting SRSs to the base station 105-b. The UE 115-b may receive the additional control signaling activating/indicating the SRS set/SRS resource list at 360 based on receiving the reference signal at 350, transmitting the measurement report at 355, or both. For example, the control signaling at 360 may indicate/activate an SRS set/SRS resource list which supports a quantity of SRS ports that corresponds to the quantity of SRS ports supported by the UE 115-b which were indicated via the measurement report at 355. The additional control signaling which provides the indication/activation of the respective SRS set and/or SRS resource list at 325 may include a DCI message, a MAC-CE message, an RRC reconfiguration message, or any combination thereof.

In general, the network may utilize the control signaling at 360 to dynamically update the SRS set/SRS resource list used for codebook and non-codebook based communications, and for fast uplink antenna panel selection at the UE 115-b. In cases where the control signaling at 360 includes a DCI message, the UE 115-b may determine SRI fields, TPMI fields, or both in the DCI message based on the active SRS set or active SRS resource list. For example, the SRI fields and/or TPMI fields, field length, and codepoint mapping may be based on the active SRS configuration.

In some cases, the SRS set/SRS resource list at the UE 115-b may be dynamically updated via dedicated signaling at 360. For example, a dedicated MAC-CE message at 360 may indicate the update of the active SRS set/SRS resource list configured for codebook and non-codebook based MIMO communications. This dynamic update may be applied to periodic, semi-persistent, and aperiodic active SRS sets/SRS resource lists. In some cases, the MAC-CE message may indicate the new SRS set/SRS resource list (e.g., indicate the update to the SRS set/SRS resource list) by indicating a UE capability value set identifier, an SRS set identifier, an SRS resource list identifier, or any combination thereof. To improve reliability, and as described previously herein, the UE 115-b may update then active SRS set/SRS resource list some time interval 380 (e.g., 3 ms) after the MAC-CE message, and/or some time interval 380 after a feedback message (e.g., ACK) responsive to the MAC-CE message at 360.

In cases where the SRS configuration includes multiple SRS sets corresponding to different maximum numbers of supported SRS sets, only the indicated SRS set may be active for codebook/non-codebook communications at any one time, where all other SRS sets are inactive or suspended. Accordingly, in some cases, the control signaling at 360 may activate the new SRS set and deactivate the old SRS set, where explicit signaling for deactivation/suspension of the old SRS set may not be necessary. Conversely in other cases, additional control signaling (not shown) may deactivate the old SRS set, and the control signaling at 360 may serve to activate the new SRS set. Comparatively, in cases where the SRS configuration includes multiple SRS resource lists corresponding to different maximum numbers of supported SRS sets, only the indicated SRS resource list may be active for codebook/non-codebook communications at any one time, and all other SRS resource lists are inactive and not used. As such, in cases where the SRS configuration includes multiple SRS resource lists, explicit deactivation signaling for the old SRS resource list may not be necessary.

In additional or alternative implementations, the control signaling at 360 used to dynamically update the SRS set/SRS resource list may include legacy SRS indication signaling. For example, the control signaling at 360 may include an RRC reconfiguration message that indicates an update to a periodic SRS set for codebook and non-codebook based MIMO communications. By way of another example, the control signaling may include MAC-CE signaling to deactivate the old SRS set and activate the new SRS set, or DCI signaling to trigger a different SRS set. In cases where the control signaling at 360 includes legacy SRS indication signaling, additional signaling for explicit deactivation/suspension of the old SRS set/old SRS resource list may be needed. For example, at 360, a first MAC-CE may deactivate a first SRS set used to transmit the first SRS at 345, and a second MAC-CE may activate a second SRS set which will be used to transmit subsequent SRSs.

In some implementations, existing signaling may be enhanced to indicate the update for the SRS set/SRS resource list for the UE 115-b at 360. For example, in some cases, the control signaling at 360 providing the dynamic SRS update may include an enhanced TCI activation MAC-CE message. In this example, the MAC-CE message may indicate the updated SRS set/SRS resource list via a UE capability value set identifier, an SRS set identifier, or an SRS resource list identifier, where the UE 115-b uses the respective identifier in the MAC-CE message to identify/select the new active SRS set/SRS resource list. In this example, the information in the MAC-CE message indicating the SRS update may be included or associated with a TCI state (e.g., via RRC signaling), or included in the MAC-CE and indicated together with activated TCI states. As noted previously, in the context of enhanced TCI activation MAC-CE messages, the UE 115-b may be configured to update the SRS set/SRS resource list some time interval 380 (e.g., 3 ms) after the MAC-CE message and/or some time interval 380 after a feedback message (e.g., ACK at 370) for the MAC-CE message. The new, updated SRS set/SRS resource list may be applied to the first SRS transmission occasion if the SRS is periodic or semi-persistent, or to the first triggered SRS scheduling if the SRS is aperiodic (some time interval 380 after the ACK at 370).

By way of another example, the dynamic update to the SRS set/SRS resource list at 360 may be indicated by an enhanced TCI indication DCI message. In such cases, the TCI codepoint in DCI message (or dedicated field in the DCI message) may be used to indicate the updated SRS set/SRS resource list via a UE capability value set identifier, an SRS set identifier, or an SRS resource list identifier. Once again, the UE 115-b may be configured to update the SRS set/SRS resource list some time interval 380 (e.g., Y ‘ms) after the DCI message at 360, and/or some time interval 380 after a feedback message (e.g., ACK at 370) responsive to the DCI message at 360. By way of another example, the dynamic update to the SRS set/SRS resource list at 360 may be indicated by an enhanced SRS-request DCI message, such as in the context of aperiodic SRS sets. In this example, an SRS request field in the SRS-request DCI message may be enhanced to jointly indicate an aperiodic SRS trigger identifier and an SRS set indicator/SRS resource list indicator. Additionally, or alternatively, an SRS-request DCI message may indicate the SRS update via an SRS request field and dedicated SRS set field/SRS resource list field.

At 365, the UE 115-b may select an antenna panel from the multiple antenna panels at the UE 115-b which will be used for wireless communications with the base station 105-b. The UE 115-b may select the antenna panel at 370 based on receiving the additional control signaling including the indication/activation of the SRS set/SRS resource list at 360. In this regard, the UE 115-b may select the antenna panel at 365 based on the dynamic update to the SRS set/SRS resource list indicated at 360. Any discussion regarding the antenna panel selection at 330 may be regarded as applying to the antenna panel selection at 365, unless noted otherwise herein.

At 370, the UE 115-b may transmit a feedback message (e.g., HARQ-ACK/NACK message) to the base station 105-b. In some aspects, the UE 115-b may transmit the feedback message in response to receiving the additional control signaling at 360 which provides the dynamic update of the SRS set/SRS resource list. In this regard, the feedback message may serve as an acknowledgement of the SRS set and/or SRS resource list which was indicated/activated at 360. Moreover, as described previously herein, in some implementations, the UE 115-b may be configured to update the SRS set/SRS resource list some time interval 380 (e.g., 3 ms, Y′ ms) after transmitting the feedback message responsive to the dynamic SRS update received at 360. In this regard, any discussion regarding the feedback message at 335 (and corresponding SRS activation following the feedback message at 335) may be regarded as applying to the feedback message at 370, unless noted otherwise herein.

At 375, the UE 115-b may receive, from the base station 105-b, a request for an SRS. In some cases, the UE 115-b may receive (and the base station 105-b may transmit) the SRS request at 375 based on transmitting/receiving additional control signaling indicating/activating an SRS set/SRS resource list at 360, transmitting/receiving the feedback message at 370, or both. For example, the base station 105-b may transmit a DCI message or MAC-CE message including a request for an SRS in response to the feedback message. In some aspects, the SRS request may include an allocation of resources which will be used for transmitting the requested SRS. Any discussion regarding the SRS request at 340 may be regarded as applying to the SRS request at 375, unless noted otherwise herein.

At 380, the UE 115-b may transmit a second SRS (e.g., a second set of SRSs) to the base station 105-b. In particular, the UE 115-b may transmit the second SRS in accordance with the SRS configuration indicated via the control signaling at 310, and in accordance with the quantity of SRS ports supported by the UE 115-b, as indicated via the measurement report at 355. For example, the UE 115-b may transmit the second SRS at 380 using the antenna panel selected at 365, and in response to the SRS request at 375. Any discussion regarding the first SRS at 345 may be regarded as applying to the second SRS at 380, unless noted otherwise herein. For example, the UE 115-b may transmit the second SRS in accordance with the SRS configuration. In particular, the UE 115-b may transmit the second SRS in accordance with the SRS update received via the control signaling at 360.

Techniques described herein may support signaling and configurations which enable UEs 115 to quickly and efficiently identify SRS sets/SRS resource lists, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of layers/SRS ports, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system.

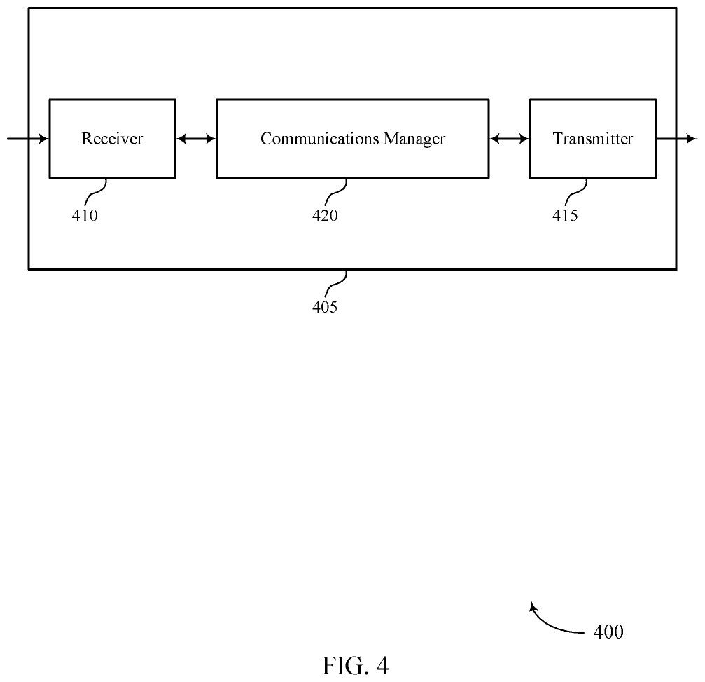

FIG. 4 shows a block diagram 400 of a device 405 that supports techniques for SRS configurations for uplink panel selection in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for SRS configurations for uplink panel selection). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for SRS configurations for uplink panel selection). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for SRS configurations for uplink panel selection as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for transmitting, to a base station, capability signaling indicating a quantity of SRS ports supported by an antenna panel of a set of multiple antenna panels at the UE. The communications manager 420 may be configured as or otherwise support a means for receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The communications manager 420 may be configured as or otherwise support a means for transmitting, to the base station and based on the control signaling, a measurement report indicating a quantity of SRS ports. The communications manager 420 may be configured as or otherwise support a means for transmitting an SRS to the base station in accordance with the SRS configuration and the indicated quantity of SRS ports.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for signaling and configurations which enable UEs 115 to quickly and efficiently identify SRS sets/SRS resource lists, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of layers/SRS ports, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system.

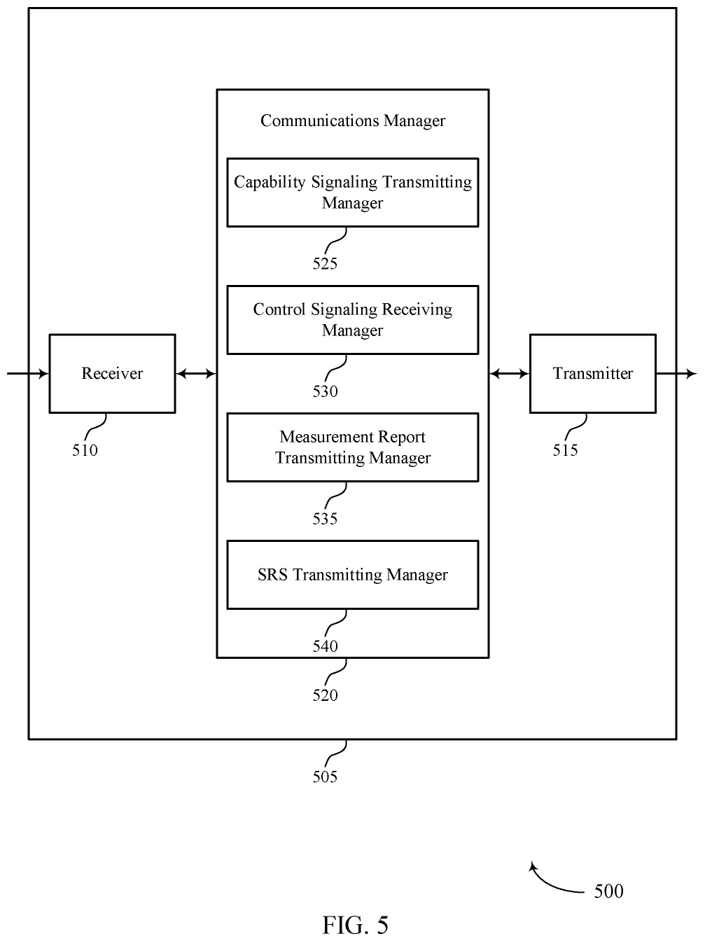

FIG. 5 shows a block diagram 500 of a device 505 that supports techniques for SRS configurations for uplink panel selection in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for SRS configurations for uplink panel selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for SRS configurations for uplink panel selection). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for SRS configurations for uplink panel selection as described herein. For example, the communications manager 520 may include a capability signaling transmitting manager 525, a control signaling receiving manager 530, a measurement report transmitting manager 535, an SRS transmitting manager 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The capability signaling transmitting manager 525 may be configured as or otherwise support a means for transmitting, to a base station, capability signaling indicating a quantity of SRS ports supported by an antenna panel of a set of multiple antenna panels at the UE. The control signaling receiving manager 530 may be configured as or otherwise support a means for receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The measurement report transmitting manager 535 may be configured as or otherwise support a means for transmitting, to the base station and based on the control signaling, a measurement report indicating a quantity of SRS ports. The SRS transmitting manager 540 may be configured as or otherwise support a means for transmitting an SRS to the base station in accordance with the SRS configuration and the indicated quantity of SRS ports.

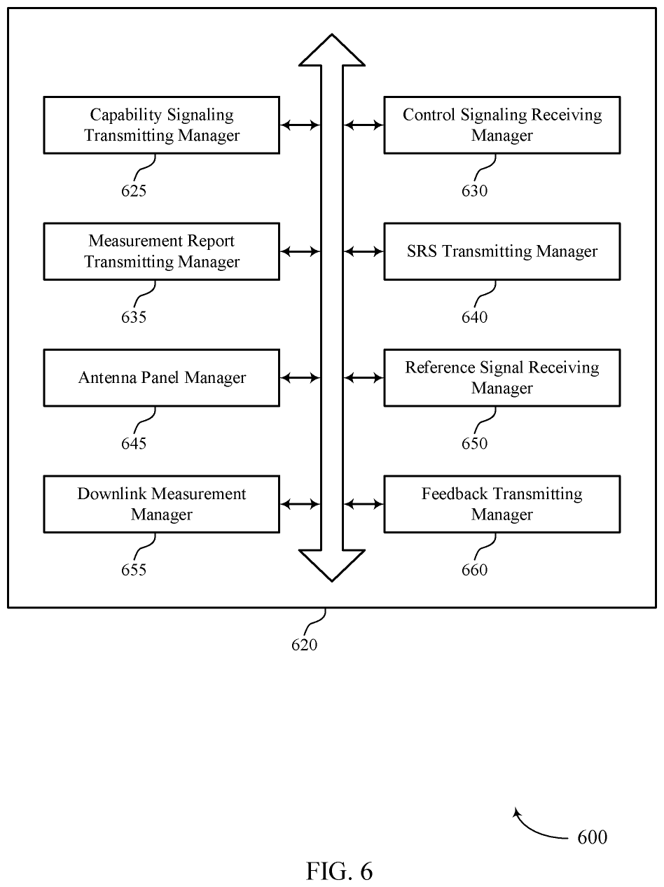

FIG. 6 shows a block diagram 600 of a communications manager 620 that supports techniques for SRS configurations for uplink panel selection in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for SRS configurations for uplink panel selection as described herein. For example, the communications manager 620 may include a capability signaling transmitting manager 625, a control signaling receiving manager 630, a measurement report transmitting manager 635, an SRS transmitting manager 640, an antenna panel manager 645, a reference signal receiving manager 650, a downlink measurement manager 655, a feedback transmitting manager 660, or any combination thereof. Each of these components may communicate, directly or indirectly, with one another (e.g., via one or more buses).

The communications manager 620 may support wireless communication at a UE in accordance with examples as disclosed herein. The capability signaling transmitting manager 625 may be configured as or otherwise support a means for transmitting, to a base station, capability signaling indicating a quantity of SRS ports supported by an antenna panel of a set of multiple antenna panels at the UE. The control signaling receiving manager 630 may be configured as or otherwise support a means for receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The measurement report transmitting manager 635 may be configured as or otherwise support a means for transmitting, to the base station and based on the control signaling, a measurement report indicating a quantity of SRS ports. The SRS transmitting manager 640 may be configured as or otherwise support a means for transmitting an SRS to the base station in accordance with the SRS configuration and the indicated quantity of SRS ports.

In some examples, to support transmitting the SRS, the SRS transmitting manager 640 may be configured as or otherwise support a means for transmitting the SRS in accordance with an SRS set of the set of multiple SRS sets corresponding to the indicated quantity of SRS ports, or transmitting the SRS in accordance with an SRS resource list of the set of multiple SRS resource lists corresponding to the indicated quantity of SRS ports.

In some examples, the antenna panel manager 645 may be configured as or otherwise support a means for selecting an antenna panel from the set of multiple antenna panels at the UE based on the indicated quantity of SRS ports, where the SRS is transmitted via the selected antenna panel.

In some examples, the measurement report transmitting manager 635 may be configured as or otherwise support a means for transmitting, via the measurement report, an indication of the first quantity of supported SRS ports, where the SRS is transmitted in accordance with the first SRS set.

In some examples, the first SRS set is associated with a first set of parameters and the second SRS set is associated with a second set of parameters that is the same or different from the first set of parameters. In some examples, the first set of parameters, the second set of parameters, or both, include a unified TCI state, a power control parameter, a periodicity, a corresponding CSI-RS, an aperiodic trigger, an offset, or any combination thereof.

In some examples, the measurement report transmitting manager 635 may be configured as or otherwise support a means for transmitting, via the measurement report, an indication of the first quantity of supported SRS ports, where the SRS is transmitted in accordance with the first SRS resource list. In some examples, the first SRS resource list is associated with a first set of parameters and the second SRS resource list is associated with a second set of parameters different from the first set of parameters. In some examples, the first set of parameters, the second set of parameters, or both, include a unified TCI state, a power control parameter, a periodicity, a corresponding CSI-RS, an aperiodic trigger, an offset, or any combination thereof.

In some examples, the control signaling receiving manager 630 may be configured as or otherwise support a means for receiving, via the control signaling, additional control signaling, or both, an indication of a second SRS configuration associated with a second BWP, a second component carrier, or both, where the second SRS configuration includes a second set of multiple SRS sets, a second set of multiple SRS resources lists, or both, where the second set of multiple SRS sets and the second set of multiple SRS resource lists are associated with respective quantities of supported SRS ports.

In some examples, the control signaling receiving manager 630 may be configured as or otherwise support a means for receiving, from the base station and based on the SRS configuration, additional control signaling including an indication of a second SRS set, a second SRS resource list, or both. In some examples, the SRS transmitting manager 640 may be configured as or otherwise support a means for transmitting, to the base station based on the additional control signaling, a second SRS in accordance with the second SRS set, the second SRS resource list, or both.

In some examples, the feedback transmitting manager 660 may be configured as or otherwise support a means for transmitting an acknowledgement message to the base station in response to the additional control signaling, where the second SRS is transmitted based on the acknowledgement message.

In some examples, to support transmitting the second SRS, the SRS transmitting manager 640 may be configured as or otherwise support a means for transmitting the second SRS after an expiration of a time interval, where the time interval is initiated based on transmitting the acknowledgement message.

In some examples, the indication of the second SRS set, the second SRS resource list, or both, is indicated via one or more bit fields within the additional control signaling. In some examples, the one or more bit fields include an SRS resource identifier field, a transmit precoder metrics indicator field, or both. In some examples, the indication of the second SRS set, the second SRS resource list, or both, is indicated via a UE capability identifier, an SRS set identifier, an SRS resource list identifier, or any combination thereof.

In some examples, the downlink measurement manager 655 may be configured as or otherwise support a means for performing one or more measurements on a downlink reference signal received from the base station. In some examples, the measurement report transmitting manager 635 may be configured as or otherwise support a means for transmitting, to the base station, a second measurement report based on the one or more measurements, the second measurement report indicating a second quantity of SRS ports, where the additional control signaling is received based on the second measurement report.

In some examples, the additional control signaling includes a DCI message, a MAC-CE message, an RRC reconfiguration message, or any combination thereof. In some examples, the control signaling receiving manager 630 may be configured as or otherwise support a means for receiving, via the additional control signaling, an indication of a deactivation of the first SRS set, the first SRS resource list, or both, where transmitting the second SRS is based on receiving the indication of the deactivation.

In some examples, the additional control signaling includes a MAC-CE message. In some examples, the indication of the second SRS set, the second SRS resource list, or both, is indicated via an activation of a TCI. In some examples, the additional control signaling includes a DCI message. In some examples, the indication of the second SRS set, the second SRS resource list, or both, is indicated via an indication of a TCI codepoint, a TCI field, or both. In some examples, the additional control signaling includes a DCI message associated with a request for SRSs. In some examples, the indication of the second SRS set, the second SRS resource list, or both, is indicated via an SRS request field.

In some examples, the capability signaling transmitting manager 625 may be configured as or otherwise support a means for transmitting, via the capability signaling, an indication of a first quantity of SRS ports supported by the first antenna panel and a second quantity of SRS ports supported by the second antenna panel.

In some examples, the control signaling receiving manager 630 may be configured as or otherwise support a means for receiving, via the control signaling, an indication of one or more periodicities associated with the SRS configuration, where transmitting the SRS includes transmitting a set of multiple SRSs in accordance with a periodicity from the one or more periodicities. In some examples, the SRS configuration is associated with codebook-based communications between the UE and the base station, non-codebook-based communications between the UE and the base station, or both.

In some examples, the reference signal receiving manager 650 may be configured as or otherwise support a means for receiving a downlink reference signal from the base station. In some examples, the downlink measurement manager 655 may be configured as or otherwise support a means for performing one or more measurements on the downlink reference signal, where transmitting the measurement report is based on the one or more measurements. In some examples, the control signaling includes an RRC message. In some examples, the measurement report includes a channel state information report associated with a channel between the UE and the base station.

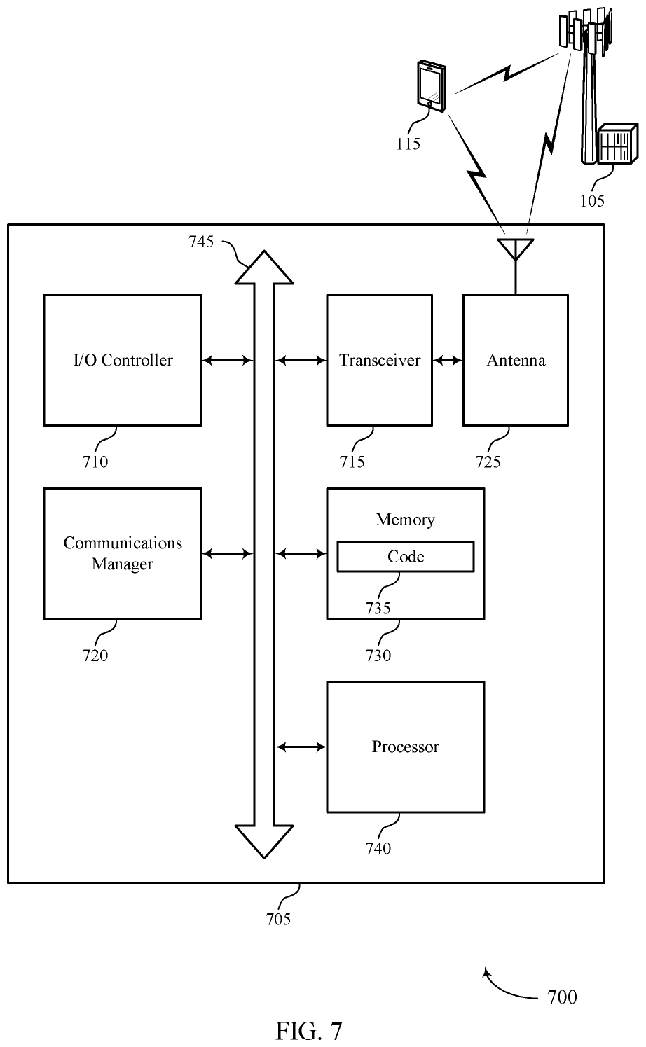

FIG. 7 shows a diagram of a system 700 including a device 705 that supports techniques for SRS configurations for uplink panel selection in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2R, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for SRS configurations for uplink panel selection). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for transmitting, to a base station, capability signaling indicating a quantity of SRS ports supported by an antenna panel of a set of multiple antenna panels at the UE. The communications manager 720 may be configured as or otherwise support a means for receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The communications manager 720 may be configured as or otherwise support a means for transmitting, to the base station and based on the control signaling, a measurement report indicating a quantity of SRS ports. The communications manager 720 may be configured as or otherwise support a means for transmitting an SRS to the base station in accordance with the SRS configuration and the indicated quantity of SRS ports.

By including or configuring the communications manager 720 in accordance with examples as described herein, the device 705 may support techniques for signaling and configurations which enable UEs 115 to quickly and efficiently identify SRS sets/SRS resource lists, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of layers/SRS ports, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for SRS configurations for uplink panel selection as described herein, or the processor 740 and the memory 730 may be otherwise configured to perform or support such operations.

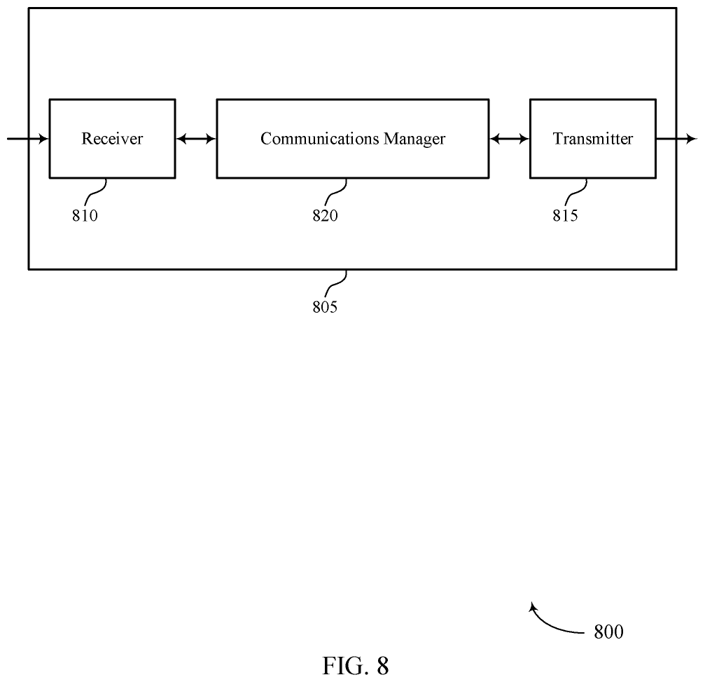

FIG. 8 shows a block diagram 800 of a device 805 that supports techniques for SRS configurations for uplink panel selection in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for SRS configurations for uplink panel selection). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for SRS configurations for uplink panel selection). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for SRS configurations for uplink panel selection as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a base station in accordance with examples as disclosed herein. For example, the communications manager 820 may be configured as or otherwise support a means for receiving, from a UE, capability signaling indicating a quantity of SRS ports supported by an antenna panel of a set of multiple antenna panels at the UE. The communications manager 820 may be configured as or otherwise support a means for transmitting, to the UE in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The communications manager 820 may be configured as or otherwise support a means for receiving, from the UE and based on the control signaling, a measurement report indicating a quantity of SRS ports. The communications manager 820 may be configured as or otherwise support a means for receiving an SRS from the UE in accordance with the SRS configuration and the indicated quantity of SRS ports.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for signaling and configurations which enable UEs 115 to quickly and efficiently identify SRS sets/SRS resource lists, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of layers/SRS ports, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system.

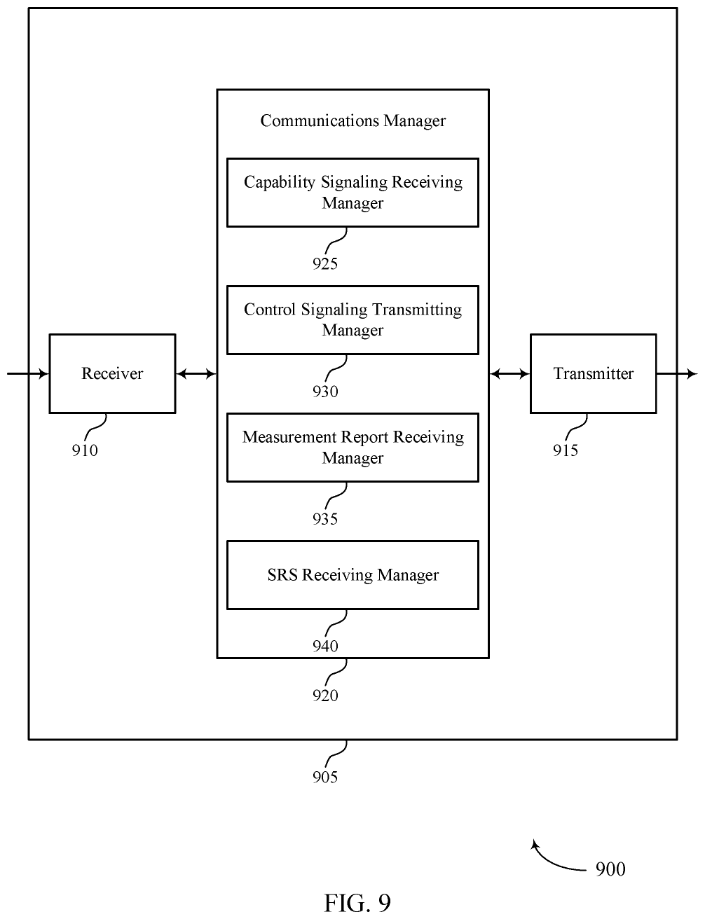

FIG. 9 shows a block diagram 900 of a device 905 that supports techniques for SRS configurations for uplink panel selection in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for SRS configurations for uplink panel selection). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for SRS configurations for uplink panel selection). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for SRS configurations for uplink panel selection as described herein. For example, the communications manager 920 may include a capability signaling receiving manager 925, a control signaling transmitting manager 930, a measurement report receiving manager 935, an SRS receiving manager 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. The capability signaling receiving manager 925 may be configured as or otherwise support a means for receiving, from a UE, capability signaling indicating a quantity of SRS ports supported by an antenna panel of a set of multiple antenna panels at the UE. The control signaling transmitting manager 930 may be configured as or otherwise support a means for transmitting, to the UE in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The measurement report receiving manager 935 may be configured as or otherwise support a means for receiving, from the UE and based on the control signaling, a measurement report indicating a quantity of SRS ports. The SRS receiving manager 940 may be configured as or otherwise support a means for receiving an SRS from the UE in accordance with the SRS configuration and the indicated quantity of SRS ports.

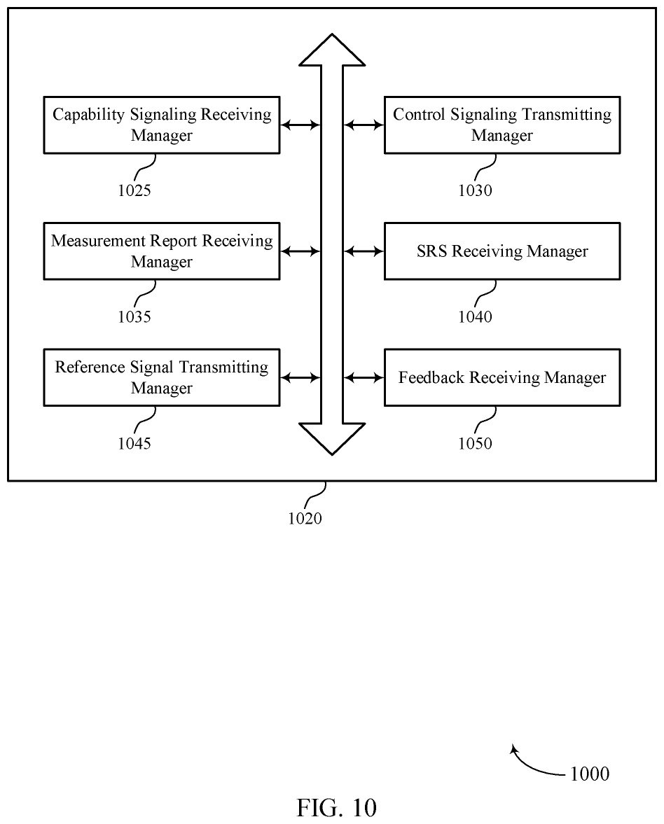

FIG. 10 shows a block diagram 1000 of a communications manager 1020 that supports techniques for SRS configurations for uplink panel selection in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for SRS configurations for uplink panel selection as described herein. For example, the communications manager 1020 may include a capability signaling receiving manager 1025, a control signaling transmitting manager 1030, a measurement report receiving manager 1035, an SRS receiving manager 1040, a reference signal transmitting manager 1045, a feedback receiving manager 1050, or any combination thereof. Each of these components may communicate, directly or indirectly, with one another (e.g., via one or more buses).

The communications manager 1020 may support wireless communication at a base station in accordance with examples as disclosed herein. The capability signaling receiving manager 1025 may be configured as or otherwise support a means for receiving, from a UE, capability signaling indicating a quantity of SRS ports supported by an antenna panel of a set of multiple antenna panels at the UE. The control signaling transmitting manager 1030 may be configured as or otherwise support a means for transmitting, to the UE in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The measurement report receiving manager 1035 may be configured as or otherwise support a means for receiving, from the UE and based on the control signaling, a measurement report indicating a quantity of SRS ports. The SRS receiving manager 1040 may be configured as or otherwise support a means for receiving an SRS from the UE in accordance with the SRS configuration and the indicated quantity of SRS ports.

In some examples, to support receiving the SRS, the SRS receiving manager 1040 may be configured as or otherwise support a means for receiving the SRS in accordance with an SRS set of the set of multiple SRS sets corresponding to the indicated quantity of SRS ports, or receiving the SRS in accordance with an SRS resource list of the set of multiple SRS resource lists corresponding to the indicated quantity of SRS ports.

In some examples, the measurement report receiving manager 1035 may be configured as or otherwise support a means for receiving, via the measurement report, an indication of the first quantity of supported SRS ports, where the SRS is received in accordance with the first SRS set. In some examples, the first SRS set is associated with a first set of parameters and the second SRS set is associated with a second set of parameters that is the same or different from the first set of parameters. In some examples, the first set of parameters, the second set of parameters, or both, include a unified TCI state, a power control parameter, a periodicity, a corresponding CSI-RS, an aperiodic trigger, an offset, or any combination thereof.

In some examples, the measurement report receiving manager 1035 may be configured as or otherwise support a means for receiving, via the measurement report, an indication of the first quantity of supported SRS ports, where the SRS is received in accordance with the first SRS resource list. In some examples, the first SRS resource list is associated with a first set of parameters and the second SRS resource list is associated with a second set of parameters different from the first set of parameters. In some examples, the first set of parameters, the second set of parameters, or both, include a unified TCI state, a power control parameter, a periodicity, a corresponding CSI-RS, an aperiodic trigger, an offset, or any combination thereof.

In some examples, the control signaling transmitting manager 1030 may be configured as or otherwise support a means for transmitting, via the control signaling, additional control signaling, or both, an indication of a second SRS configuration associated with a second BWP, a second component carrier, or both, where the second SRS configuration includes a second set of multiple SRS sets, a second set of multiple SRS resources lists, or both, where the second set of multiple SRS sets and the second set of multiple SRS resource lists is associated with a respective quantity of supported SRS ports.

In some examples, the control signaling transmitting manager 1030 may be configured as or otherwise support a means for transmitting, to the UE and based on the SRS configuration, additional control signaling including an indication of a second SRS set, a second SRS resource list, or both. In some examples, SRS receiving manager 1040 may be configured as or otherwise support a means for receiving, from the UE based on the additional control signaling, a second SRS in accordance with the second SRS set, the second SRS resource list, or both.

In some examples, the feedback receiving manager 1050 may be configured as or otherwise support a means for receiving an acknowledgement message to the base station in response to the additional control signaling, where the second SRS is receiving based on the acknowledgement message.

In some examples, to support receiving the second SRS, the SRS receiving manager 1040 may be configured as or otherwise support a means for receiving the second SRS after an expiration of a time interval. In some examples, the indication of the second SRS set, the second SRS resource list, or both, is indicated via one or more bit fields within the additional control signaling. In some examples, the one or more bit fields include an SRS resource identifier field, a transmit precoder metrics indicator field, or both. In some examples, the indication of the second SRS set, the second SRS resource list, or both, is indicated via a UE capability identifier, an SRS set identifier, an SRS resource list identifier, or any combination thereof.

In some examples, the reference signal transmitting manager 1045 may be configured as or otherwise support a means for transmitting a downlink reference signal to the UE. In some examples, the measurement report receiving manager 1035 may be configured as or otherwise support a means for receiving, from the UE, a second measurement report based on the downlink reference signal, the second measurement report indicating a second quantity of SRS ports, where the additional control signaling is transmitted based on the second measurement report. In some examples, the additional control signaling includes a DCI message, a MAC-CE message, an RRC reconfiguration message, or any combination thereof.

In some examples, the control signaling transmitting manager 1030 may be configured as or otherwise support a means for transmitting, via the additional control signaling, an indication of a deactivation of the first SRS set, the first SRS resource list, or both, where receiving the second SRS is based on transmitting the indication of the deactivation.

In some examples, the additional control signaling includes a MAC-CE message. In some examples, the indication of the second SRS set, the second SRS resource list, or both, is indicated via an activation of a TCI. In some examples, the additional control signaling includes a DCI message. In some examples, the indication of the second SRS set, the second SRS resource list, or both, is indicated via an indication of a TCI codepoint, a TCI field, or both. In some examples, the additional control signaling includes a DCI message associated with a request for SRSs. In some examples, the indication of the second SRS set, the second SRS resource list, or both, is indicated via an SRS request field.

In some examples, the capability signaling receiving manager 1025 may be configured as or otherwise support a means for receiving, via the capability signaling, an indication of a first quantity of SRS ports supported by the first antenna panel and a second quantity of SRS ports supported by the second antenna panel.

In some examples, the control signaling transmitting manager 1030 may be configured as or otherwise support a means for transmitting, via the control signaling, an indication of one or more periodicities associated with the SRS configuration, where receiving the SRS includes receiving a set of multiple SRSs in accordance with a periodicity from the one or more periodicities. In some examples, the SRS configuration is associated with codebook-based communications between the UE and the base station, non-codebook-based communications between the UE and the base station, or both.

In some examples, the reference signal transmitting manager 1045 may be configured as or otherwise support a means for transmitting a downlink reference signal from the base station, where receiving the measurement report is based on the downlink reference signal. In some examples, the control signaling includes an RRC message. In some examples, the measurement report includes a channel state information report associated with a channel between the UE and the base station.

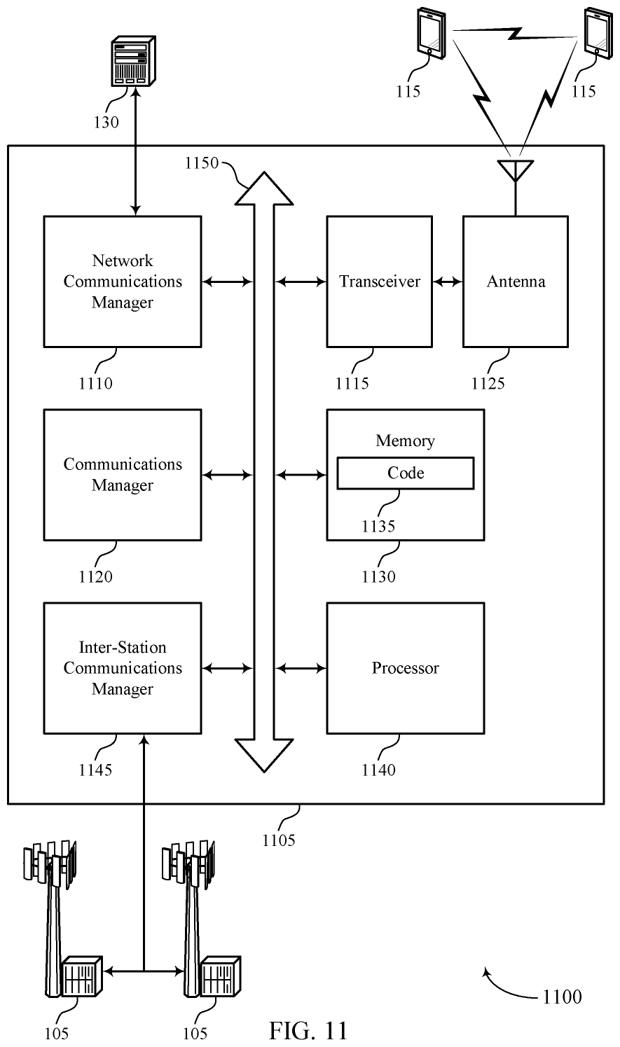

FIG. 11 shows a diagram of a system 1100 including a device 1105 that supports techniques for SRS configurations for uplink panel selection in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for SRS configurations for uplink panel selection). For example, the device 1105 or a component of the device 1105 may include a processor 1140 and memory 1130 coupled with or to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station in accordance with examples as disclosed herein. For example, the communications manager 1120 may be configured as or otherwise support a means for receiving, from a UE, capability signaling indicating a quantity of SRS ports supported by an antenna panel of a set of multiple antenna panels at the UE. The communications manager 1120 may be configured as or otherwise support a means for transmitting, to the UE in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The communications manager 1120 may be configured as or otherwise support a means for receiving, from the UE and based on the control signaling, a measurement report indicating a quantity of SRS ports. The communications manager 1120 may be configured as or otherwise support a means for receiving an SRS from the UE in accordance with the SRS configuration and the indicated quantity of SRS ports.

By including or configuring the communications manager 1120 in accordance with examples as described herein, the device 1105 may support techniques for signaling and configurations which enable UEs 115 to quickly and efficiently identify SRS sets/SRS resource lists, and corresponding antenna panels, which will be used to transmit SRSs. In this regard, techniques described herein may enable fast uplink antenna panel selection for multi-panel UEs 115. In particular, aspects of the present disclosure support signaling and configurations which enable UEs 115 to be configured with multiple SRS sets which support varying quantities of layers/SRS ports, which enables UEs 115 to efficiently identify which antenna panels and SRS sets will be used to transmit SRSs to the network. By enabling improved identification and selection of applicable SRS sets and antenna panels, aspects of the present disclosure may reduce latency and improve resource utilization within the wireless communications system.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for SRS configurations for uplink panel selection as described herein, or the processor 1140 and the memory 1130 may be otherwise configured to perform or support such operations.

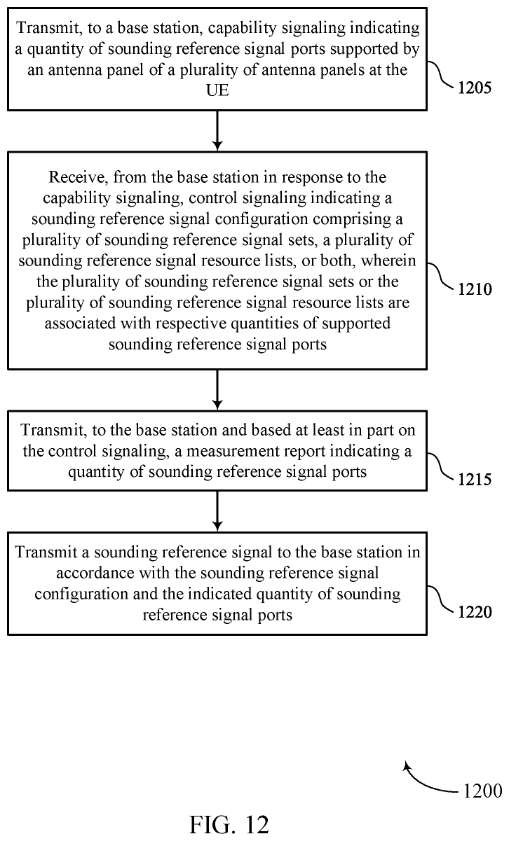

FIG. 12 shows a flowchart illustrating a method 1200 that supports techniques for SRS configurations for uplink panel selection in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include transmitting, to a base station, capability signaling indicating a quantity of SRS ports supported by an antenna panel of a set of multiple antenna panels at the UE. The operations of 1205 may be performed in accordance with examples as disclosed herein. In some examples, aspects of the operations of 1205 may be performed by a capability signaling transmitting manager 625 as described with reference to FIG. 6.

At 1210, the method may include receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The operations of 1210 may be performed in accordance with examples as disclosed herein. In some examples, aspects of the operations of 1210 may be performed by a control signaling receiving manager 630 as described with reference to FIG. 6.

At 1215, the method may include transmitting, to the base station and based on the control signaling, a measurement report indicating a quantity of SRS ports. The operations of 1215 may be performed in accordance with examples as disclosed herein. In some examples, aspects of the operations of 1215 may be performed by a measurement report transmitting manager 635 as described with reference to FIG. 6.

At 1220, the method may include transmitting an SRS to the base station in accordance with the SRS configuration and the indicated quantity of SRS ports. The operations of 1220 may be performed in accordance with examples as disclosed herein. In some examples, aspects of the operations of 1220 may be performed by an SRS transmitting manager 640 as described with reference to FIG. 6.

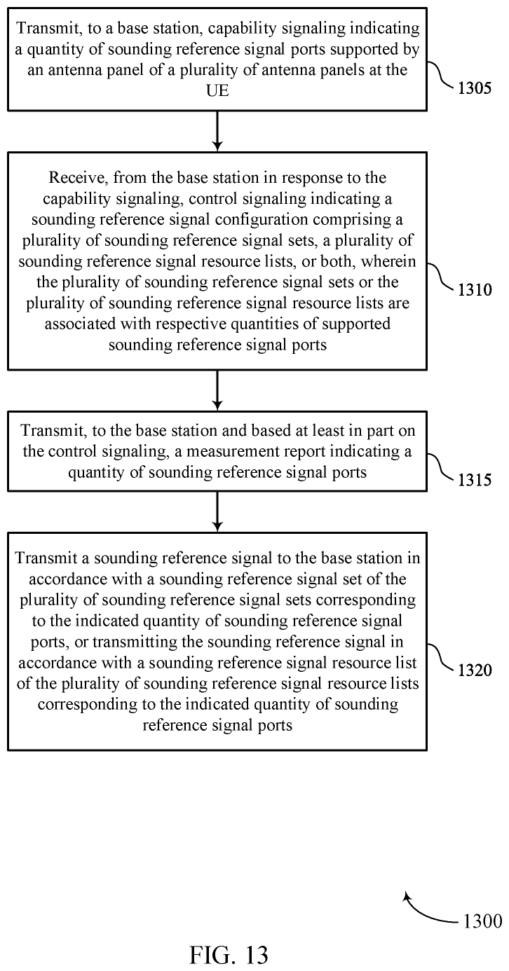

FIG. 13 shows a flowchart illustrating a method 1300 that supports techniques for SRS configurations for uplink panel selection in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include transmitting, to a base station, capability signaling indicating a quantity of SRS ports supported by an antenna panel of a set of multiple antenna panels at the UE. The operations of 1305 may be performed in accordance with examples as disclosed herein. In some examples, aspects of the operations of 1305 may be performed by a capability signaling transmitting manager 625 as described with reference to FIG. 6.

At 1310, the method may include receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The operations of 1310 may be performed in accordance with examples as disclosed herein. In some examples, aspects of the operations of 1310 may be performed by a control signaling receiving manager 630 as described with reference to FIG. 6.

At 1315, the method may include transmitting, to the base station and based on the control signaling, a measurement report indicating a quantity of SRS ports. The operations of 1315 may be performed in accordance with examples as disclosed herein. In some examples, aspects of the operations of 1315 may be performed by a measurement report transmitting manager 635 as described with reference to FIG. 6.

At 1320, the method may include transmitting an SRS to the base station in accordance with an SRS set of the set of multiple SRS sets corresponding to the indicated quantity of SRS ports, or transmitting the SRS in accordance with an SRS resource list of the set of multiple SRS resource lists corresponding to the indicated quantity of SRS ports. The operations of 1320 may be performed in accordance with examples as disclosed herein. In some examples, aspects of the operations of 1320 may be performed by an SRS transmitting manager 640 as described with reference to FIG. 6.

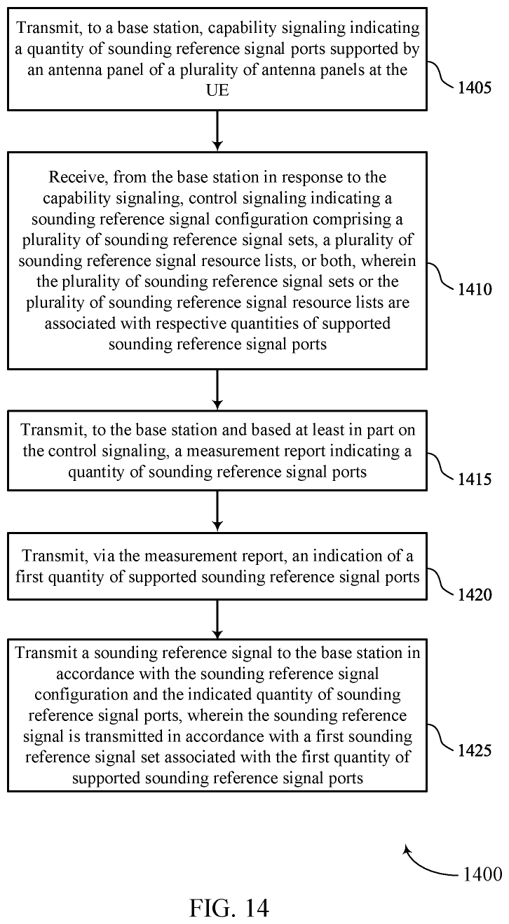

FIG. 14 shows a flowchart illustrating a method 1400 that supports techniques for SRS configurations for uplink panel selection in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include transmitting, to a base station, capability signaling indicating a quantity of SRS ports supported by an antenna panel of a set of multiple antenna panels at the UE. The operations of 1405 may be performed in accordance with examples as disclosed herein. In some examples, aspects of the operations of 1405 may be performed by a capability signaling transmitting manager 625 as described with reference to FIG. 6.

At 1410, the method may include receiving, from the base station in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The operations of 1410 may be performed in accordance with examples as disclosed herein. In some examples, aspects of the operations of 1410 may be performed by a control signaling receiving manager 630 as described with reference to FIG. 6.

At 1415, the method may include transmitting, to the base station and based on the control signaling, a measurement report indicating a quantity of SRS ports. The operations of 1415 may be performed in accordance with examples as disclosed herein.

In some examples, aspects of the operations of 1415 may be performed by a measurement report transmitting manager 635 as described with reference to FIG. 6.

At 1420, the method may include transmitting, via the measurement report, an indication of a first quantity of supported SRS ports. The operations of 1420 may be performed in accordance with examples as disclosed herein. In some examples, aspects of the operations of 1420 may be performed by a measurement report transmitting manager 635 as described with reference to FIG. 6.

At 1425, the method may include transmitting an SRS to the base station in accordance with the SRS configuration and the indicated quantity of SRS ports, where the SRS is transmitted in accordance with a first SRS set associated with the first quantity of supported sounding reference signal ports. The operations of 1425 may be performed in accordance with examples as disclosed herein. In some examples, aspects of the operations of 1425 may be performed by an SRS transmitting manager 640 as described with reference to FIG. 6.

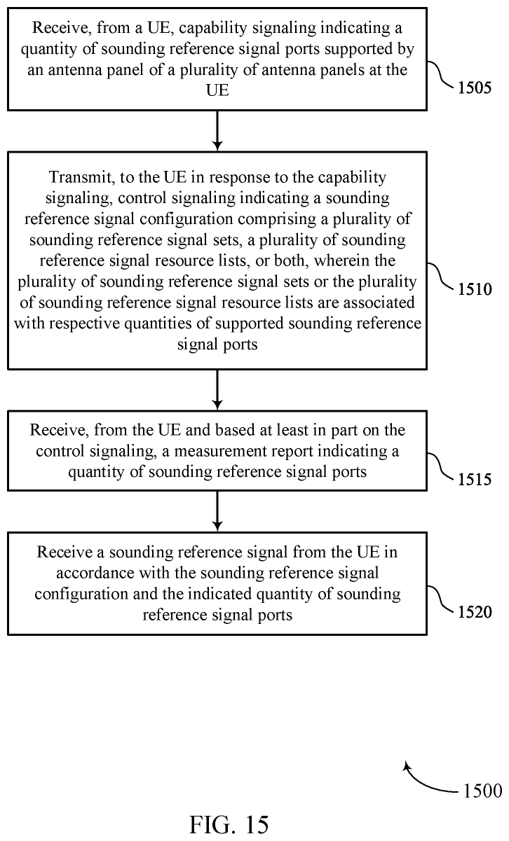

FIG. 15 shows a flowchart illustrating a method 1500 that supports techniques for SRS configurations for uplink panel selection in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include receiving, from a UE, capability signaling indicating a quantity of SRS ports supported by an antenna panel of a set of multiple antenna panels at the UE. The operations of 1505 may be performed in accordance with examples as disclosed herein. In some examples, aspects of the operations of 1505 may be performed by a capability signaling receiving manager 1025 as described with reference to FIG. 10.

At 1510, the method may include transmitting, to the UE in response to the capability signaling, control signaling indicating an SRS configuration including a set of multiple SRS sets, a set of multiple SRS resource lists, or both, where the set of multiple SRS sets or the set of multiple SRS resource lists are associated with respective quantities of supported SRS ports. The operations of 1510 may be performed in accordance with examples as disclosed herein. In some examples, aspects of the operations of 1510 may be performed by a control signaling transmitting manager 1030 as described with reference to FIG. 10.

At 1515, the method may include receiving, from the UE and based on the control signaling, a measurement report indicating a quantity of SRS ports. The operations of 1515 may be performed in accordance with examples as disclosed herein. In some examples, aspects of the operations of 1515 may be performed by a measurement report receiving manager 1035 as described with reference to FIG. 10.

At 1520, the method may include receiving an SRS from the UE in accordance with the SRS configuration and the indicated quantity of SRS ports. The operations of 1520 may be performed in accordance with examples as disclosed herein. In some examples, aspects of the operations of 1520 may be performed by an SRS receiving manager 1040 as described with reference to FIG. 10.

The following provides an overview of aspects of the present disclosure:

Aspect 1: A method for wireless communication at a UE, comprising: transmitting, to a base station, capability signaling indicating a quantity of SRS ports supported by an antenna panel of a plurality of antenna panels at the UE: receiving, from the base station in response to the capability signaling, control signaling indicating a SRS configuration comprising a plurality of SRS sets, a plurality of SRS resource lists, or both, wherein the plurality of SRS sets or the plurality of SRS resource lists are associated with respective quantities of supported SRS ports: transmitting, to the base station and based at least in part on the control signaling, a measurement report indicating a quantity of SRS ports; and transmitting a SRS to the base station in accordance with the SRS configuration and the indicated quantity of SRS ports.

Aspect 2: The method of aspect 1, wherein transmitting the SRS comprises: transmitting the SRS in accordance with a SRS set of the plurality of SRS sets corresponding to the indicated quantity of SRS ports, or transmitting the SRS in accordance with a SRS resource list of the plurality of SRS resource lists corresponding to the indicated quantity of SRS ports.

Aspect 3: The method of any of aspects 1 through 2, further comprising: selecting an antenna panel from the plurality of antenna panels at the UE based at least in part on the indicated quantity of SRS ports, wherein the SRS is transmitted via the selected antenna panel.

Aspect 4: The method of any of aspects 1 through 3, wherein the plurality of SRS sets comprises a first SRS set associated with a first quantity of supported SRS ports and a second SRS set associated with a second quantity of supported SRS ports, the method further comprising: transmitting, via the measurement report, an indication of the first quantity of supported SRS ports, wherein the SRS is transmitted in accordance with the first SRS set.

Aspect 5: The method of aspect 4, wherein the first SRS set is associated with a first set of parameters and the second SRS set is associated with a second set of parameters that is the same or different from the first set of parameters, the first set of parameters, the second set of parameters, or both, comprise a unified TCI state, a power control parameter, a periodicity, a corresponding CSI-RS, an aperiodic trigger, an offset, or any combination thereof.

Aspect 6: The method of any of aspects 1 through 5, wherein the plurality of SRS resource lists comprises a first SRS resource list associated with a first quantity of supported SRS ports and a second SRS resource list associated with a second quantity of supported SRS ports, the method further comprising: transmitting, via the measurement report, an indication of the first quantity of supported SRS ports, wherein the SRS is transmitted in accordance with the first SRS resource list.

Aspect 7: The method of aspect 6, wherein the first SRS resource list is associated with a first set of parameters and the second SRS resource list is associated with a second set of parameters different from the first set of parameters, the first set of parameters, the second set of parameters, or both, comprise a unified TCI state, a power control parameter, a periodicity, a corresponding CSI-RS, an aperiodic trigger, an offset, or any combination thereof.

Aspect 8: The method of any of aspects 1 through 7, wherein the SRS configuration is associated with a first BWP, a first component carrier, or both, the method further comprising: receiving, via the control signaling, additional control signaling, or both, an indication of a second SRS configuration associated with a second BWP, a second component carrier, or both, wherein the second SRS configuration comprises a second plurality of SRS sets, a second plurality of SRS resources lists, or both, wherein the second plurality of SRS sets and the second plurality of SRS resource lists are associated with respective quantities of supported SRS ports.

Aspect 9: The method of any of aspects 1 through 8, wherein transmitting the SRS comprises transmitting the SRS in accordance with a first SRS set, a first SRS resource list, or both, the method further comprising: receiving, from the base station and based at least in part on the SRS configuration, additional control signaling comprising an indication of a second SRS set, a second SRS resource list, or both; and transmitting, to the base station based at least in part on the additional control signaling, a second SRS in accordance with the second SRS set, the second SRS resource list, or both.

Aspect 10: The method of aspect 9, further comprising: transmitting an acknowledgement message to the base station in response to the additional control signaling, wherein the second SRS is transmitted based at least in part on the acknowledgement message.

Aspect 11: The method of aspect 10, wherein transmitting the second SRS comprises: transmitting the second SRS after an expiration of a time interval, wherein the time interval is initiated based at least in part on transmitting the acknowledgement message.

Aspect 12: The method of any of aspects 9 through 11, wherein the indication of the second SRS set, the second SRS resource list, or both, is indicated via one or more bit fields within the additional control signaling, the one or more bit fields comprise a SRS resource identifier field, a transmit precoder metrics indicator field, or both.

Aspect 13: The method of any of aspects 9 through 12, wherein the indication of the second SRS set, the second SRS resource list, or both, is indicated via a UE capability identifier, a SRS set identifier, a SRS resource list identifier, or any combination thereof.

Aspect 14: The method of any of aspects 9 through 13, further comprising: performing one or more measurements on a downlink reference signal received from the base station; and transmitting, to the base station, a second measurement report based at least in part on the one or more measurements, the second measurement report indicating a second quantity of SRS ports, wherein the additional control signaling is received based at least in part on the second measurement report.

Aspect 15: The method of any of aspects 9 through 14, wherein the additional control signaling comprises a BWP message, a MAC-CE message, an RRC reconfiguration message, or any combination thereof.

Aspect 16: The method of any of aspects 9 through 15, further comprising: receiving, via the additional control signaling, an indication of a deactivation of the first SRS set, the first SRS resource list, or both, wherein transmitting the second SRS is based at least in part on receiving the indication of the deactivation.

Aspect 17: The method of any of aspects 9 through 16, wherein the additional control signaling comprises a MAC-CE message, and the indication of the second SRS set, the second SRS resource list, or both, is indicated via an activation of a TCI.

Aspect 18: The method of any of aspects 9 through 17, wherein the additional control signaling comprises a BWP message, and the indication of the second SRS set, the second SRS resource list, or both, is indicated via an indication of a TCI codepoint, a TCI field, or both.

Aspect 19: The method of any of aspects 9 through 18, wherein the additional control signaling comprises a BWP message associated with a request for SRSs, and the indication of the second SRS set, the second SRS resource list, or both, is indicated via a SRS request field.

Aspect 20: The method of any of aspects 1 through 19, wherein the plurality of antenna panels at the UE comprise a first antenna panel and a second antenna panel, the method further comprising: transmitting, via the capability signaling, an indication of a first quantity of SRS ports supported by the first antenna panel and a second quantity of SRS ports supported by the second antenna panel.

Aspect 21: The method of any of aspects 1 through 20, further comprising: receiving, via the control signaling, an indication of one or more periodicities associated with the SRS configuration, wherein transmitting the SRS comprises transmitting a plurality of SRSs in accordance with a periodicity from the one or more periodicities.

Aspect 22: The method of any of aspects 1 through 21, wherein the SRS configuration is associated with codebook-based communications between the UE and the base station, non-codebook-based communications between the UE and the base station, or both.

Aspect 23: The method of any of aspects 1 through 22, further comprising: receiving a downlink reference signal from the base station; and performing one or more measurements on the downlink reference signal, wherein transmitting the measurement report is based at least in part on the one or more measurements.

Aspect 24: The method of any of aspects 1 through 23, wherein the control signaling comprises an RRC message, and the measurement report comprises a channel state information report associated with a channel between the UE and the base station.

Aspect 25: A method for wireless communication at a base station, comprising: receiving, from a UE, capability signaling indicating a quantity of SRS ports supported by an antenna panel of a plurality of antenna panels at the UE: transmitting, to the UE in response to the capability signaling, control signaling indicating a SRS configuration comprising a plurality of SRS sets, a plurality of SRS resource lists, or both, wherein the plurality of SRS sets or the plurality of SRS resource lists are associated with respective quantities of supported SRS ports: receiving, from the UE and based at least in part on the control signaling, a measurement report indicating a quantity of SRS ports; and receiving a SRS from the UE in accordance with the SRS configuration and the indicated quantity of SRS ports.

Aspect 26: The method of aspect 25, wherein receiving the SRS comprises: receiving the SRS in accordance with a SRS set of the plurality of SRS sets corresponding to the indicated quantity of SRS ports, or receiving the SRS in accordance with a SRS resource list of the plurality of SRS resource lists corresponding to the indicated quantity of SRS ports.

Aspect 27: The method of any of aspects 25 through 26, wherein the plurality of SRS sets comprises a first SRS set associated with a first quantity of supported SRS ports and a second SRS set associated with a second quantity of supported SRS ports, the method further comprising: receiving, via the measurement report, an indication of the first quantity of supported SRS ports, wherein the SRS is received in accordance with the first SRS set.

Aspect 28: The method of aspect 27, wherein the first SRS set is associated with a first set of parameters and the second SRS set is associated with a second set of parameters that is the same or different from the first set of parameters, the first set of parameters, the second set of parameters, or both, comprise a unified TCI state, a power control parameter, a periodicity, a corresponding CSI-RS, an aperiodic trigger, an offset, or any combination thereof.

Aspect 29: The method of any of aspects 25 through 28, wherein the plurality of SRS resource lists comprises a first SRS resource list associated with a first quantity of supported SRS ports and a second SRS resource list associated with a second quantity of supported SRS ports, the method further comprising: receiving, via the measurement report, an indication of the first quantity of supported SRS ports, wherein the SRS is received in accordance with the first SRS resource list.

Aspect 30: The method of aspect 29, wherein the first SRS resource list is associated with a first set of parameters and the second SRS resource list is associated with a second set of parameters different from the first set of parameters, the first set of parameters, the second set of parameters, or both, comprise a unified TCI state, a power control parameter, a periodicity, a corresponding CSI-RS, an aperiodic trigger, an offset, or any combination thereof.

Aspect 31: The method of any of aspects 25 through 30, wherein the SRS configuration is associated with a first BWP, a first component carrier, or both, the method further comprising: transmitting, via the control signaling, additional control signaling, or both, an indication of a second SRS configuration associated with a second BWP, a second component carrier, or both, wherein the second SRS configuration comprises a second plurality of SRS sets, a second plurality of SRS resources lists, or both, wherein the second plurality of SRS sets and the second plurality of SRS resource lists is associated with a respective quantity of supported SRS ports.

Aspect 32: The method of any of aspects 25 through 31, wherein receiving the SRS comprises receiving the SRS in accordance with a first SRS set, a first SRS resource list, or both, the method further comprising: transmitting, to the UE and based at least in part on the SRS configuration, additional control signaling comprising an indication of a second SRS set, a second SRS resource list, or both; and receiving, from the UE based at least in part on the additional control signaling, a second SRS in accordance with the second SRS set, the second SRS resource list, or both.

Aspect 33: The method of aspect 32, further comprising: receiving an acknowledgement message to the base station in response to the additional control signaling, wherein the second SRS is receiving based at least in part on the acknowledgement message.

Aspect 34: The method of aspect 33, wherein receiving the second SRS comprises: receiving the second SRS after an expiration of a time interval.

Aspect 35: The method of any of aspects 32 through 34, wherein the indication of the second SRS set, the second SRS resource list, or both, is indicated via one or more bit fields within the additional control signaling, the one or more bit fields comprise a SRS resource identifier field, a transmit precoder metrics indicator field, or both.

Aspect 36: The method of any of aspects 32 through 35, wherein the indication of the second SRS set, the second SRS resource list, or both, is indicated via a UE capability identifier, a SRS set identifier, a SRS resource list identifier, or any combination thereof.

Aspect 37: The method of any of aspects 32 through 36, further comprising:

transmitting a downlink reference signal to the UE; and receiving, from the UE, a second measurement report based at least in part on the downlink reference signal, the second measurement report indicating a second quantity of SRS ports, wherein the additional control signaling is transmitted based at least in part on the second measurement report.

Aspect 38: The method of any of aspects 32 through 37, wherein the additional control signaling comprises a BWP message, a MAC-CE message, an RRC reconfiguration message, or any combination thereof.

Aspect 39: The method of any of aspects 32 through 38, further comprising: transmitting, via the additional control signaling, an indication of a deactivation of the first SRS set, the first SRS resource list, or both, wherein receiving the second SRS is based at least in part on transmitting the indication of the deactivation.

Aspect 40: The method of any of aspects 32 through 39, wherein the additional control signaling comprises a MAC-CE message, and the indication of the second SRS set, the second SRS resource list, or both, is indicated via an activation of a TCI.

Aspect 41: The method of any of aspects 32 through 40, wherein the additional control signaling comprises a BWP message, and the indication of the second SRS set, the second SRS resource list, or both, is indicated via an indication of a TCI codepoint, a TCI field, or both.

Aspect 42: The method of any of aspects 32 through 41, wherein the additional control signaling comprises a BWP message associated with a request for SRSs, and the indication of the second SRS set, the second SRS resource list, or both, is indicated via a SRS request field.

Aspect 43: The method of any of aspects 25 through 42, wherein the plurality of antenna panels at the UE comprise a first antenna panel and a second antenna panel, the method further comprising: receiving, via the capability signaling, an indication of a first quantity of SRS ports supported by the first antenna panel and a second quantity of SRS ports supported by the second antenna panel.

Aspect 44: The method of any of aspects 25 through 43, further comprising: transmitting, via the control signaling, an indication of one or more periodicities associated with the SRS configuration, wherein receiving the SRS comprises receiving a plurality of SRSs in accordance with a periodicity from the one or more periodicities.

Aspect 45: The method of any of aspects 25 through 44, wherein the SRS configuration is associated with codebook-based communications between the UE and the base station, non-codebook-based communications between the UE and the base station, or both.

Aspect 46: The method of any of aspects 25 through 45, further comprising: transmitting a downlink reference signal from the base station, wherein receiving the measurement report is based at least in part on the downlink reference signal.

Aspect 47: The method of any of aspects 25 through 46, wherein the control signaling comprises an RRC message, and the measurement report comprises a channel state information report associated with a channel between the UE and the base station.

Aspect 48: An apparatus for wireless communication at a UE, comprising a processor: memory coupled with the processor; and instructions stored in the memory and executable by the processor to cause the apparatus to perform a method of any of aspects 1 through 24.

Aspect 49: An apparatus for wireless communication at a UE, comprising at least one means for performing a method of any of aspects 1 through 24.

Aspect 50: A non-transitory computer-readable medium storing code for wireless communication at a UE, the code comprising instructions executable by a processor to perform a method of any of aspects 1 through 24.

Aspect 51: An apparatus for wireless communication at a base station, comprising a processor: memory coupled with the processor; and instructions stored in the memory and executable by the processor to cause the apparatus to perform a method of any of aspects 25 through 47.

Aspect 52: An apparatus for wireless communication at a base station, comprising at least one means for performing a method of any of aspects 25 through 47.

Aspect 53: A non-transitory computer-readable medium storing code for wireless communication at a base station, the code comprising instructions executable by a processor to perform a method of any of aspects 25 through 47.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to a base station, capability signaling indicating a quantity of sounding reference signal ports supported by an antenna panel of a plurality of antenna panels at the UE;
receiving, from the base station in response to the capability signaling, control signaling indicating a sounding reference signal configuration comprising a plurality of sounding reference signal sets, a plurality of sounding reference signal resource lists, or both, wherein the plurality of sounding reference signal sets or the plurality of sounding reference signal resource lists are associated with respective quantities of supported sounding reference signal ports;
transmitting, to the base station and based at least in part on the control signaling, a measurement report indicating a quantity of sounding reference signal ports; and
transmitting a sounding reference signal to the base station in accordance with the sounding reference signal configuration and the indicated quantity of sounding reference signal ports.

2. The method of claim 1, wherein transmitting the sounding reference signal comprises:
transmitting the sounding reference signal in accordance with a sounding reference signal set of the plurality of sounding reference signal sets corresponding to the indicated quantity of sounding reference signal ports, or transmitting the sounding reference signal in accordance with a sounding reference signal resource list of the plurality of sounding reference signal resource lists corresponding to the indicated quantity of sounding reference signal ports.

3. The method of claim 1, further comprising:
selecting an antenna panel from the plurality of antenna panels at the UE based at least in part on the indicated quantity of sounding reference signal ports, wherein the sounding reference signal is transmitted via the selected antenna panel.

4. The method of claim 1, wherein the plurality of sounding reference signal sets comprises a first sounding reference signal set associated with a first quantity of supported sounding reference signal ports and a second sounding reference signal set associated with a second quantity of supported sounding reference signal ports, the method further comprising:
transmitting, via the measurement report, an indication of the first quantity of supported sounding reference signal ports, wherein the sounding reference signal is transmitted in accordance with the first sounding reference signal set.

5. The method of claim 4, wherein the first sounding reference signal set is associated with a first set of parameters and the second sounding reference signal set is associated with a second set of parameters that is the same or different from the first set of parameters, wherein the first set of parameters, the second set of parameters, or both, comprise a unified transmission configuration indicator state, a power control parameter, a periodicity, a corresponding channel state information reference signal, an aperiodic trigger, an offset, or any combination thereof.

6. The method of claim 1, wherein the plurality of sounding reference signal resource lists comprises a first sounding reference signal resource list associated with a first quantity of supported sounding reference signal ports and a second sounding reference signal resource list associated with a second quantity of supported sounding reference signal ports, the method further comprising:
transmitting, via the measurement report, an indication of the first quantity of supported sounding reference signal ports, wherein the sounding reference signal is transmitted in accordance with the first sounding reference signal resource list.

7. The method of claim 6, wherein the first sounding reference signal resource list is associated with a first set of parameters and the second sounding reference signal resource list is associated with a second set of parameters different from the first set of parameters, wherein the first set of parameters, the second set of parameters, or both, comprise a unified transmission configuration indicator state, a power control parameter, a periodicity, a corresponding channel state information reference signal, an aperiodic trigger, an offset, or any combination thereof.

8. The method of claim 1, wherein the sounding reference signal configuration is associated with a first bandwidth part, a first component carrier, or both, the method further comprising:
receiving, via the control signaling, additional control signaling, or both, an indication of a second sounding reference signal configuration associated with a second bandwidth part, a second component carrier, or both, wherein the second sounding reference signal configuration comprises a second plurality of sounding reference signal sets, a second plurality of sounding reference signal resources lists, or both, wherein the second plurality of sounding reference signal sets and the second plurality of sounding reference signal resource lists are associated with respective quantities of supported sounding reference signal ports.

9. The method of claim 1, wherein transmitting the sounding reference signal comprises transmitting the sounding reference signal in accordance with a first sounding reference signal set, a first sounding reference signal resource list, or both, the method further comprising:
receiving, from the base station and based at least in part on the sounding reference signal configuration, additional control signaling comprising an indication of a second sounding reference signal set, a second sounding reference signal resource list, or both; and
transmitting, to the base station based at least in part on the additional control signaling, a second sounding reference signal in accordance with the second sounding reference signal set, the second sounding reference signal resource list, or both.

10. The method of claim 9, further comprising:
transmitting an acknowledgement message to the base station in response to the additional control signaling, wherein the second sounding reference signal is transmitted based at least in part on the acknowledgement message.

11. The method of claim 10, wherein transmitting the second sounding reference signal comprises:
transmitting the second sounding reference signal after an expiration of a time interval, wherein the time interval is initiated based at least in part on transmitting the acknowledgement message.

12. The method of claim 9, wherein the indication of the second sounding reference signal set, the second sounding reference signal resource list, or both, is indicated via one or more bit fields within the additional control signaling, wherein the one or more bit fields comprise a sounding reference signal resource identifier field, a transmit precoder metrics indicator field, or both.

13. The method of claim 9, wherein the indication of the second sounding reference signal set, the second sounding reference signal resource list, or both, is indicated via a UE capability identifier, a sounding reference signal set identifier, a sounding reference signal resource list identifier, or any combination thereof.

14. The method of claim 9, further comprising:
performing one or more measurements on a downlink reference signal received from the base station; and
transmitting, to the base station, a second measurement report based at least in part on the one or more measurements, the second measurement report indicating a second quantity of sounding reference signal ports, wherein the additional control signaling is received based at least in part on the second measurement report.

15. The method of claim 9, wherein the additional control signaling comprises a downlink control information message, a medium access control-control element message, a radio resource control reconfiguration message, or any combination thereof.

16. The method of claim 9, further comprising:
receiving, via the additional control signaling, an indication of a deactivation of the first sounding reference signal set, the first sounding reference signal resource list, or both, wherein transmitting the second sounding reference signal is based at least in part on receiving the indication of the deactivation.

17. The method of claim 9, wherein the additional control signaling comprises a medium access control-control element message, and wherein the indication of the second sounding reference signal set, the second sounding reference signal resource list, or both, is indicated via an activation of a transmission configuration indicator.

18. The method of claim 9, wherein the additional control signaling comprises a downlink control information message, and wherein the indication of the second sounding reference signal set, the second sounding reference signal resource list, or both, is indicated via an indication of a transmission configuration indicator codepoint, a transmission configuration indicator field, or both.

19. The method of claim 9, wherein the additional control signaling comprises a downlink control information message associated with a request for sounding reference signals, and wherein the indication of the second sounding reference signal set, the second sounding reference signal resource list, or both, is indicated via a sounding reference signal request field.

20. The method of claim 1, wherein the plurality of antenna panels at the UE comprise a first antenna panel and a second antenna panel, the method further comprising:
transmitting, via the capability signaling, an indication of a first quantity of sounding reference signal ports supported by the first antenna panel and a second quantity of sounding reference signal ports supported by the second antenna panel.

21. The method of claim 1, further comprising:
receiving, via the control signaling, an indication of one or more periodicities associated with the sounding reference signal configuration, wherein transmitting the sounding reference signal comprises transmitting a plurality of sounding reference signals in accordance with a periodicity from the one or more periodicities.

22. The method of claim 1, wherein the sounding reference signal configuration is associated with codebook-based communications between the UE and the base station, non-codebook-based communications between the UE and the base station, or both.

23. The method of claim 1, further comprising:
receiving a downlink reference signal from the base station; and
performing one or more measurements on the downlink reference signal, wherein transmitting the measurement report is based at least in part on the one or more measurements.

24. The method of claim 1, wherein the control signaling comprises a radio resource control message, and wherein the measurement report comprises a channel state information report associated with a channel between the UE and the base station.

25. A method for wireless communication at a base station, comprising:
receiving, from a user equipment (UE), capability signaling indicating a quantity of sounding reference signal ports supported by an antenna panel of a plurality of antenna panels at the UE;
transmitting, to the UE in response to the capability signaling, control signaling indicating a sounding reference signal configuration comprising a plurality of sounding reference signal sets, a plurality of sounding reference signal resource lists, or both, wherein the plurality of sounding reference signal sets or the plurality of sounding reference signal resource lists are associated with respective quantities of supported sounding reference signal ports;
receiving, from the UE and based at least in part on the control signaling, a measurement report indicating a quantity of sounding reference signal ports; and
receiving a sounding reference signal from the UE in accordance with the sounding reference signal configuration and the indicated quantity of sounding reference signal ports.

26. The method of claim 25, wherein receiving the sounding reference signal comprises:
receiving the sounding reference signal in accordance with a sounding reference signal set of the plurality of sounding reference signal sets corresponding to the indicated quantity of sounding reference signal ports, or receiving the sounding reference signal in accordance with a sounding reference signal resource list of the plurality of sounding reference signal resource lists corresponding to the indicated quantity of sounding reference signal ports.

27. The method of claim 25, wherein the plurality of sounding reference signal sets comprises a first sounding reference signal set associated with a first quantity of supported sounding reference signal ports and a second sounding reference signal set associated with a second quantity of supported sounding reference signal ports, the method further comprising:
receiving, via the measurement report, an indication of the first quantity of supported sounding reference signal ports, wherein the sounding reference signal is received in accordance with the first sounding reference signal set.

28. The method of claim 27, wherein the first sounding reference signal set is associated with a first set of parameters and the second sounding reference signal set is associated with a second set of parameters that is the same or different from the first set of parameters, wherein the first set of parameters, the second set of parameters, or both, comprise a unified transmission configuration indicator state, a power control parameter, a periodicity, a corresponding channel state information reference signal, an aperiodic trigger, an offset, or any combination thereof.

29. An apparatus for wireless communication at a user equipment (UE), comprising:
a processor;
memory coupled with the processor; and
instructions stored in the memory and executable by the processor to cause the apparatus to:
transmit, to a base station, capability signaling indicating a quantity of sounding reference signal ports supported by an antenna panel of a plurality of antenna panels at the UE;
receive, from the base station in response to the capability signaling, control signaling indicating a sounding reference signal configuration comprising a plurality of sounding reference signal sets, a plurality of sounding reference signal resource lists, or both, wherein the plurality of sounding reference signal sets or the plurality of sounding reference signal resource lists are associated with respective quantities of supported sounding reference signal ports;
transmit, to the base station and based at least in part on the control signaling, a measurement report indicating a quantity of sounding reference signal ports; and
transmit a sounding reference signal to the base station in accordance with the sounding reference signal configuration and the indicated quantity of sounding reference signal ports.

30. An apparatus for wireless communication at a base station, comprising:
a processor;
memory coupled with the processor; and
instructions stored in the memory and executable by the processor to cause the apparatus to:
receive, from a user equipment (UE), capability signaling indicating a quantity of sounding reference signal ports supported by an antenna panel of a plurality of antenna panels at the UE;
transmit, to the UE in response to the capability signaling, control signaling indicating a sounding reference signal configuration comprising a plurality of sounding reference signal sets, a plurality of sounding reference signal resource lists, or both, wherein the plurality of sounding reference signal sets or the plurality of sounding reference signal resource lists are associated with respective quantities of supported sounding reference signal ports;
receive, from the UE and based at least in part on the control signaling, a measurement report indicating a quantity of sounding reference signal ports; and
receive a sounding reference signal from the UE in accordance with the sounding reference signal configuration and the indicated quantity of sounding reference signal ports.
